(19) United States
(12) Patent Application Publication
(10) Pub. No.: US 2025/0063079 A1
(43) Pub. Date: Feb. 20, 2025

(54) SEAMLESS SPLIT RENDERING SESSION RELOCATION BETWEEN SPLIT RENDERING SERVERS SUPPORTING EXTENDED REALITY APPLICATIONS IN MOBILE COMMUNICATION NETWORKS

(71) Applicant: Nokia Technologies Oy, Espoo (FI)

(72) Inventors: Thibaud BIATEK, Massy (FR); Sivasothy SHANMUGALINGAM, Massy (FR); Abdelaali CHAOUB, Massy (FR); Daniel Philip VENMANI, Massy (FR)

(21) Appl. No.: 18/803,462

(22) Filed: Aug. 13, 2024

Related U.S. Application Data
(60) Provisional application No. 63/519,807, filed on Aug. 15, 2023.

(51) Int. Cl. H04L 65/80; H04L 65/1083; H04L 65/65

(52) U.S. Cl. CPC H04L 65/80; H04L 65/1083; H04L 65/65

(57) ABSTRACT

Methods, apparatuses, and computer program products are provided for facilitating seamless split rendering session relocation when a quality of a rendered viewport for extended Reality (XR) media content from a current split rendering server becomes degraded. A new split rendering server can be provisioned in parallel with the current split rendering server and a rendered viewport negotiation or comparison can be carried out. A split rendering client can provide pose information and sensor data for viewport and/or field of view prediction to both the current split rendering server and the new split rendering server during a transition period. The current split rendering server can continue during this transition period to provide rendered viewport-specific XR media content to the split rendering client while an application function or session management function determines when the split rendering session should be relocated to the newly provisioned split rendering server.

### CROSS-REFERENCE TO RELATED APPLICATIONS

This patent application claims the benefit of priority of U.S. Provisional Patent Application No. 63/519,807 filed Aug. 15, 2023, which is hereby incorporated by reference.

### FIELD

This disclosure generally relates to mobile communication networks such as a fifth-generation (5G) communication networks, and more particularly to seamless split rendering session relocation between split rendering servers supporting extended reality applications in mobile communication networks.

### BACKGROUND

A mobile communication network can include hardware that enable communications between user terminals and servers, such as edge servers. A communication network can include access networks, a core network and one or more communication devices. A communication network may establish sessions for communicating data, for example, communicating data carrying voice, electronic mail (email), data carrying short message service messages, multimedia and/or content data and so on. A communication system may provide services to user terminals. Non-limiting examples of services provided comprise two-way or multi-way calls, data communication or multimedia services and access to a data network, such as the Internet. In a wireless communication network, communications between user terminals and base stations of an access node occur over a wireless link.

A communication device is often referred to as a user equipment (UE) or a user device. A communication device is provided with an appropriate signal receiving and transmitting apparatus for enabling communications, for example enabling communications with a communication network or communications directly with other communication devices. The communication device may access a carrier provided by a base station or access point of an access network of a communication network and transmit and/or receive communications on the carrier.

A communication network and user terminals typically operate in accordance with a given standards or standards specifications, such as those provided by 3GPP (Third Generation Partnership Project) or ETSI (European Telecommunications Standards Institute).

### SUMMARY

Methods, apparatuses, and computer program products are provided for facilitating seamless split rendering session relocation when a quality of a rendered viewport for eXtended Reality (XR) media content from a current split rendering server becomes degraded. A new split rendering server can be provisioned in parallel with the current split rendering server and a rendered viewport negotiation or comparison can be carried out. A split rendering client can provide pose information and sensor data for viewport and/or field of view prediction to both the current split rendering server and the new split rendering server during a transition period. The current split rendering server can continue during this transition period to provide rendered viewport-specific XR media content to the split rendering client while an application function or session management function determines when the split rendering session should be relocated to the newly provisioned split rendering server. In this context, methods, systems, and computer program products supporting seamless relocation of XR split rendering services are presented.

According to some aspects, a method for seamless relocation of extended Reality (XR) and/or similar media content rendering services from a source server to a target server can be carried out. The communication network can comprise a source split rendering server and a target split rendering server and one or more computing devices configured to carry out methods for relocation of XR and/or similar media content rendering services from the source split rendering server to target split rendering server. The computer program product can comprise a non-transitory computer-readable storage medium that store instructions for carrying out methods for relocation of XR and/or similar media content rendering services from the source split rendering server to target split rendering server.

According to a first aspect, a method can comprise, during a time period, using a real-time communication (RTC) application function (AF) hosted in a session management function (SMF), a data server in a data network (DN), a policy control function (PCF), an access and mobility management function (AMF), NSSF, AUSF, UDM, NRF, UPF, and/or the like, monitoring a split rendering session at a current split rendering server to detect recurring degradations in one or more qualities, wherein the split rendering session is associated with an extended reality (XR) media content stream being provided to a split rendering client, wherein the one or more qualities comprise one or more of: a quality of service (QOS) metric, a quality of experience (QoE) metric, a key performance indicator (KPI) of the current split rendering server, or a quality of the XR media content stream, wherein the split rendering session is managed by the RTC-AF and associated with a split rendering client (SRC); determining, based on a duration of the recurring degradations in the one or more qualities exceeding a pre-determined threshold during said time period, that the split rendering session needs to be relocated from the current split rendering server; and initiating relocation of at least a portion of the split rendering session for the split rendering client from the current split rendering server to a new split rendering server.

In some embodiments, the QoS metric is selected from among: a packet loss rate, a bit rate, a bandwidth, a latency, a variance in latency, a throughput, a transmission delay, an availability, or a jitter. In some embodiments, the method further comprises: establishing a new WebRTC session, in an application layer of the communication network, between the new split rendering server and the RTC-AF. In some embodiments, the method further comprises: indicating, to the split rendering client, that a relocation procedure has been initiated. In some embodiments, the method further comprises: in the indication to the split rendering client that a relocation procedure has been initiated, including a request for the split rendering client to provide subsequent pose information and user input information to both the current split rendering server and the new split rendering server. In some embodiments, the method further comprises: receiving, at the RTC-AF, first media content for a first viewport from the current split rendering server and second media content for the first viewport from the new split rendering server. In some embodiments, the method further comprises: indicating, to an application provider (AP) in the communication network, that the split rendering session needs to be relocated. In some embodiments, the method further comprises: requesting that the new split rendering server or another server in the communication network run at least a portion of provisioning of the split rendering services for the split rendering session. In some embodiments, the method further comprises: determining whether the AP has caused the new split rendering server to run at least the portion of provisioning of the split rendering session; and, in an instance in which said determining is in the affirmative, providing, from the RTC-AF, to the AP, an indication that the current split rendering server is to be un-provisioned. In some embodiments, the method further comprises: determining one or more characteristics of the current and new split rendering servers; determining, based at least on the one or more characteristics of the current and new split rendering servers, a timeline for completing relocation of the split rendering session from the current split rendering server; and signaling the relocation timeline to the current split rendering server, the new split rendering server, and the split rendering client. In some embodiments, the signaling the relocation timeline comprises indicating a relocation time relative to an extended reality runtime or a relocation frame identifier indicating a particular frame from the XR media content stream at by which the relocation procedure is carried out.

According to a second aspect, an apparatus can be provided that comprises at least one processor; and at least one memory storing instructions that, when executed by the at least one processor, cause the apparatus to perform at least: during a time period, causing a real-time communication (RTC) application function (AF) in a communication network to monitor a split rendering session at a current split rendering server to detect recurring degradations in one or more qualities, wherein the split rendering session is associated with an extended reality (XR) media content stream being provided to a split rendering client, wherein the one or more qualities comprise one or more of: a quality of service (QOS) metric, a quality of experience (QoE) metric, a key performance indicator (KPI) of the current split rendering server, or a quality of the XR media content stream, wherein the split rendering session is managed by the RTC-AF and associated with a split rendering client (SRC); determining, based on a duration of the recurring degradations in the one or more qualities exceeding a pre-determined threshold during said time period, that the split rendering session needs to be relocated from the current split rendering server; and initiating relocation of at least a portion of the split rendering session for the split rendering client from the current split rendering server to a new split rendering server. In some embodiments, the RTC-AF can be hosted in a session management function (SMF), a data server in a data network (DN), a policy control function (PCF), an access and mobility management function (AMF), NSSF, AUSF, UDM, NRF, UPF, and/or the like,

In some embodiments, the QoS metric is selected from among: a packet loss rate, a bit rate, a bandwidth, a latency, a variance in latency, a throughput, a transmission delay, an availability, or a jitter. In some embodiments, the instructions stored on the at least one memory, when executed by the at least one processor, further cause the apparatus to perform: establishing a new WebRTC session, in an application layer of the communication network, between a new split rendering server and the RTC-AF. In some embodiments, the instructions stored on the at least one memory, when executed by the at least one processor, further cause the apparatus to perform: indicating, to the split rendering client and/or UE, that a relocation procedure has been initiated. In some embodiments, the instructions stored on the at least one memory, when executed by the at least one processor, further cause the apparatus to perform: in the indication to the split rendering client and/or UE that a relocation procedure has been initiated, including a request for the split rendering client and/or UE to provide subsequent pose information and user input information to both the current split rendering server and the new split rendering server. In some embodiments, the instructions stored on the at least one memory, when executed by the at least one processor, further cause the apparatus to perform: receiving, at the RTC-AF in the DN, first media content for a first viewport from the current split rendering server and second media content for the first viewport from the new split rendering server. In some embodiments, the instructions stored on the at least one memory, when executed by the at least one processor, further cause the apparatus to perform: indicating, to an application provider (AP) in the communication network, that the split rendering session needs to be relocated. In some embodiments, the instructions stored on the at least one memory, when executed by the at least one processor, further cause the apparatus to perform: requesting that the new split rendering server or another server in the communication network run at least a portion of provisioning of the split rendering services for the split rendering session. In some embodiments, the instructions stored on the at least one memory, when executed by the at least one processor, further cause the apparatus to perform: determining whether the AP has caused the new split rendering server to run at least the portion of provisioning of the split rendering session; and, in an instance in which said determining is in the affirmative, providing, from the RTC-AF, to the AP, an indication that the current split rendering server is to be un-provisioned. In some embodiments, the instructions stored on the at least one memory, when executed by the at least one processor, further cause the apparatus to perform: determining one or more characteristics of the current and new split rendering servers; determining, based at least on the one or more characteristics of the current and new split rendering servers, a timeline for completing relocation of the split rendering session from the current split rendering server; and signaling the relocation timeline to the current split rendering server, the new split rendering server, and the split rendering client. In some embodiments, the signaling the relocation timeline comprises indicating a relocation time relative to an extended reality runtime or a relocation frame identifier indicating a particular frame from the XR media content stream at by which the relocation procedure is carried out.

According to a third aspect, a computer program product can comprise a non-transitory computer-readable medium storing instructions that, when executed by at least one processor, cause an apparatus to perform at least: during a time period, using a real-time communication (RTC) application function (AF) hosted in a session management function (SMF) or a data network (DN) in a communication network, monitoring a split rendering session at a current split rendering server to detect recurring degradations in one or more qualities, wherein the split rendering session is associated with an extended reality (XR) media content stream being provided to a split rendering client, wherein the one or more qualities comprise one or more of: a quality of service (QOS) metric, a quality of experience (QoE) metric, a key performance indicator (KPI) of the current split rendering server, or a quality of the XR media content stream, wherein the split rendering session is managed by the RTC-AF and associated with a split rendering client (SRC); determining, based on a duration of the recurring degradations in the one or more qualities exceeding a pre-determined threshold during said time period, that the split rendering session needs to be relocated from the current split rendering server; and initiating relocation of at least a portion of the split rendering session for the split rendering client from the current split rendering server to a new split rendering server. In some embodiments, the RTC-AF can be hosted in a session management function (SMF), a data server in a data network (DN), a policy control function (PCF), an access and mobility management function (AMF), NSSF, AUSF, UDM, NRF, UPF, and/or the like,

In some embodiments, the QoS metric is selected from among: a packet loss rate, a bit rate, a bandwidth, a latency, a variance in latency, a throughput, a transmission delay, an availability, or a jitter. In some embodiments, the instructions, when executed by the at least one processor, further cause the apparatus to perform at least: establishing a new WebRTC session, in an application layer of the communication network, between a new split rendering server and the RTC-AF. In some embodiments, the instructions, when executed by the at least one processor, further cause the apparatus to perform at least: indicating, to the split rendering client and/or UE, that a relocation procedure has been initiated. In some embodiments, the instructions, when executed by the at least one processor, further cause the apparatus to perform at least: in the indication to the split rendering client that a relocation procedure has been initiated, including a request for the split rendering client to provide subsequent pose information and user input information to both the current split rendering server and the new split rendering server. In some embodiments, the instructions, when executed by the at least one processor, further cause the apparatus to perform at least: receiving, at the RTC-AF, first media content for a first viewport from the current split rendering server and second media content for the first viewport from the new split rendering server. In some embodiments, the instructions, when executed by the at least one processor, further cause the apparatus to perform at least: indicating, to an application provider (AP) in the communication network, that the split rendering session needs to be relocated. In some embodiments, the instructions, when executed by the at least one processor, further cause the apparatus to perform at least: requesting that the new split rendering server or another server in the communication network run at least a portion of provisioning of the split rendering services for the split rendering session. In some embodiments, the instructions, when executed by the at least one processor, further cause the apparatus to perform at least: determining whether the AP has caused the new split rendering server to run at least the portion of provisioning of the split rendering services for the split rendering session; and, in an instance in which said determining is in the affirmative, providing, from the RTC-AF, to the AP, an indication that the split rendering session is to be un-provisioned. In some embodiments, the instructions, when executed by the at least one processor, further cause the apparatus to perform at least: determining one or more characteristics of the current and new split rendering servers; determining, based at least on the one or more characteristics of the current and new split rendering servers, a timeline for completing relocation of the split rendering session from the current split rendering server; and signaling the relocation timeline to the current split rendering server, the new split rendering server, and the split rendering client. In some embodiments, the signaling the relocation timeline comprises indicating a relocation time relative to an extended reality runtime or a relocation frame identifier indicating a particular frame from the XR media content stream at by which the relocation procedure is carried out.

According to a fourth aspect, a method can be carried out that comprises: monitoring, during a time period, using a network node configured as a real-time communication (RTC) application function (AF) in a core network (CN) or a data network (DN) in a communication network, one or more metrics associated with a split rendering session, the split rendering session being generated by a current split rendering server, wherein the split rendering session is associated with an extended reality (XR) media content stream being provided to a split rendering client by the current split rendering server, wherein the one or more metrics comprise one or more of: a quality of service (QOS) metric, a quality of experience (QoE) metric, a key performance indicator (KPI) of the current split rendering server, or a metric associated with the XR media content stream; determining, based on a duration of occurrence of the one or more metrics exceeding a pre-determined duration threshold during the time period or a magnitude of the one or more metrics exceeding one or more respective pre-determined metric thresholds, to relocate the split rendering session from the current split rendering server to a new split rendering server; and providing, to one or more of the current split rendering server or the new split rendering server, an indication to relocate the split rendering session from the current split rendering server to the new split rendering server. In some embodiments, the RTC-AF can be hosted in a session management function (SMF), a data server in a data network (DN), a policy control function (PCF), an access and mobility management function (AMF), NSSF, AUSF, UDM, NRF, UPF, and/or the like,

In some embodiments, the QoS metric is selected from among: a packet loss rate, a bit rate, a bandwidth, a latency, a variance in latency, a throughput, a transmission delay, an availability, or a jitter. In some embodiments, the method can further comprise: managing, using the RTC-AF, a new WebRTC session established between the split rendering client and the new split rendering server. In some embodiments, the method can further comprise: providing, to the split rendering client, an indication that a relocation procedure has been initiated. In some embodiments, the method can further comprise: in the indication to the split rendering client that a relocation procedure has been initiated, including a request for the split rendering client to provide subsequent pose information and user input information to both the current split rendering server and the new split rendering server. In some embodiments, the method can further comprise: sending, from the RTC-AF, to one of the current split rendering server or the new split rendering server, a request to send, to the split rendering client, an indication that the split rendering session will be relocated from the current split rendering server to the new split rendering server. In some embodiments, the method can further comprise: receiving, at the RTC-AF, from the current split rendering server, first XR media content for a first viewport associated with the XR media content stream; receiving, at the RTC-AF, from the new split rendering server, second XR media content for the first viewport associated with the XR media content stream; and determining, based on the first XR media content and the second XR media content, to relocate the split rendering session from the current split rendering server to the new split rendering server. In some embodiments, the method can further comprise: indicating, to an application provider (AP) in the communication network, that the split rendering session will be relocated from the current split rendering server to the new split rendering server. In some embodiments, the method can further comprise: requesting that the new split rendering server or another server in the communication network run at least a portion of provisioning of the split rendering session. In some embodiments, the method can further comprise: determining that the AP has caused the new split rendering server to run at least the portion of provisioning of the split rendering services for the split rendering session; and providing, from the RTC-AF, to the AP, an indication that the split rendering session is to be un-provisioned. In some embodiments, the method can further comprise: determining one or more characteristics of the current and new split rendering servers; determining, based at least on the one or more characteristics of the current and new split rendering servers, a time for completion of relocation of the split rendering session from the current split rendering server to the new split rendering server; and sending, to the current split rendering server and the new split rendering server, an indication that the new split rendering server is to relocate the split rendering session from the current split rendering server to the new split rendering server by the time for completion of relocation of the split rendering session. In some embodiments, the sending of the indication comprises sending an indication of the time for completion of relocation of the split rendering session relative to an XR runtime or relative to a relocation frame identifier indicating a particular frame from a sequence of frames in the XR media content stream by which time the relocation of the split rendering session is to be completed.

According to a fifth aspect, an apparatus can be provided that is configured to operate in a core network (CN) or a data network (DN) of a communication network. The apparatus can be configured to operate as a real-time communication (RTC) application function (AF). The apparatus can comprise: at least one processor; and at least one memory storing instructions that, when executed by the at least one processor, cause the apparatus to perform at least: monitoring, during a time period, one or more metrics associated with a split rendering session, the split rendering session being generated by a current split rendering server, wherein the split rendering session is associated with an extended reality (XR) media content stream being provided to a split rendering client by the current split rendering server, wherein the one or more metrics comprise one or more of: a quality of service (QOS) metric, a quality of experience (QoE) metric, a key performance indicator (KPI) of the current split rendering server, or a metric associated with the XR media content stream; determining, based on a duration of occurrence of the one or more metrics exceeding a pre-determined duration threshold during the time period or a magnitude of the one or more metrics exceeding one or more respective pre-determined metric thresholds, to relocate the split rendering session from the current split rendering server to a new split rendering server; and providing, to one or more of the current split rendering server or the new split rendering server, an indication to relocate the split rendering session from the current split rendering server to the new split rendering server. In some embodiments, the RTC-AF can be hosted in a session management function (SMF), a data server in a data network (DN), a policy control function (PCF), an access and mobility management function (AMF), NSSF, AUSF, UDM, NRF, UPF, and/or the like,

In some embodiments, the QoS metric is selected from among: a packet loss rate, a bit rate, a bandwidth, a latency, a variance in latency, a throughput, a transmission delay, an availability, or a jitter. In some embodiments, the instructions stored on the at least one memory, when executed by the at least one processor, further cause the apparatus to perform: requesting establishment of a new WebRTC session between the new split rendering server and the RTC-AF. In some embodiments, the instructions stored on the at least one memory, when executed by the at least one processor, further cause the apparatus to perform: providing, to the split rendering client, an indication that a relocation procedure has been initiated. In some embodiments, the instructions stored on the at least one memory, when executed by the at least one processor, further cause the apparatus to perform: in the indication to the split rendering client that a relocation procedure has been initiated, including a request for the split rendering client to provide subsequent pose information and user input information to both the current split rendering server and the new split rendering server. In some embodiments, the instructions stored on the at least one memory, when executed by the at least one processor, further cause the apparatus to perform: sending, to one of the current split rendering server or the new split rendering server, a request to send, to the split rendering client, an indication that the split rendering session will be relocated from the current split rendering server to the new split rendering server. In some embodiments, the instructions stored on the at least one memory, when executed by the at least one processor, further cause the apparatus to perform: receiving, from the current split rendering server, first XR media content for a first viewport associated with the XR media content stream; receiving, from the new split rendering server, second XR media content for the first viewport associated with the XR media content stream; and determining, based on the first XR media content and the second XR media content, to relocate the split rendering session from the current split rendering server to the new split rendering server. In some embodiments, the instructions stored on the at least one memory, when executed by the at least one processor, further cause the apparatus to perform: indicating, to an application provider (AP) in the communication network, that the split rendering session will be relocated from the current split rendering server to the new split rendering server. In some embodiments, the instructions stored on the at least one memory, when executed by the at least one processor, further cause the apparatus to perform: requesting that an edge server in the communication network run at least a portion of provisioning of the split rendering session. In some embodiments, the instructions stored on the at least one memory, when executed by the at least one processor, further cause the apparatus to perform: determining that the AP has caused the edge server to run at least the portion of provisioning of the split rendering services for the split rendering session; and providing, to the AP, an indication that the split rendering session is to be un-provisioned. In some embodiments, the instructions stored on the at least one memory, when executed by the at least one processor, further cause the apparatus to perform: determining one or more characteristics of the current and new split rendering servers; determining, based at least on the one or more characteristics of the current and new split rendering servers, a time for completion of relocation of the split rendering session from the current split rendering server to the new split rendering server; and sending, to the current split rendering server and the new split rendering server, an indication that the new split rendering server is to relocate the split rendering session from the current split rendering server to the new split rendering server by the time for completion of relocation of the split rendering session. In some embodiments, the sending of the indication comprises sending an indication of the time for completion of relocation of the split rendering session relative to an XR runtime or relative to a relocation frame identifier indicating a particular frame from a sequence of frames in the XR media content stream by which time the relocation of the split rendering session is to be completed.

According to a sixth aspect, a computer program product can be provided that comprises a non-transitory computer-readable medium storing instructions that, when executed by at least one processor, cause an apparatus to perform at least: According to a fourth aspect, a method can be carried out that comprises: monitoring, during a time period, using a network node configured as a real-time communication (RTC) application function (AF) in a core network (CN) or a data network (DN) in a communication network, one or more metrics associated with a split rendering session, the split rendering session being generated by a current split rendering server, wherein the split rendering session is associated with an extended reality (XR) media content stream being provided to a split rendering client by the current split rendering server, wherein the one or more metrics comprise one or more of: a quality of service (QOS) metric, a quality of experience (QoE) metric, a key performance indicator (KPI) of the current split rendering server, or a metric associated with the XR media content stream; determining, based on a duration of occurrence of the one or more metrics exceeding a pre-determined duration threshold during the time period or a magnitude of the one or more metrics exceeding one or more respective pre-determined metric thresholds, to relocate the split rendering session from the current split rendering server to a new split rendering server; and providing, to one or more of the current split rendering server or the new split rendering server, an indication to relocate the split rendering session from the current split rendering server to the new split rendering server. In some embodiments, the RTC-AF can be hosted in a session management function (SMF), a data server in a data network (DN), a policy control function (PCF), an access and mobility management function (AMF), NSSF, AUSF, UDM, NRF, UPF, and/or the like,

In some embodiments, the QoS metric is selected from among: a packet loss rate, a bit rate, a bandwidth, a latency, a variance in latency, a throughput, a transmission delay, an availability, or a jitter. In some embodiments, the method can further comprise: requesting, using the RTC-AF, establishment of a new WebRTC session between the new split rendering server and the RTC-AF. In some embodiments, the method can further comprise: providing, to the split rendering client, an indication that a relocation procedure has been initiated. In some embodiments, the method can further comprise: in the indication to the split rendering client that a relocation procedure has been initiated, including a request for the split rendering client to provide subsequent pose information and user input information to both the current split rendering server and the new split rendering server. In some embodiments, the method can further comprise: sending, from the RTC-AF, to one of the current split rendering server or the new split rendering server, a request to send, to the split rendering client, an indication that the split rendering session will be relocated from the current split rendering server to the new split rendering server. In some embodiments, the method can further comprise: receiving, at the RTC AF, from the current split rendering server, first XR media content for a first viewport associated with the XR media content stream; receiving, at the RTC-AF, from the new split rendering server, second XR media content for the first viewport associated with the XR media content stream; and determining, based on the first XR media content and the second XR media content, to relocate the split rendering session from the current split rendering server to the new split rendering server. In some embodiments, the method can further comprise: indicating, to an application provider (AP) in the communication network, that the split rendering session will be relocated from the current split rendering server to the new split rendering server. In some embodiments, the method can further comprise: requesting that an edge server in the communication network run at least a portion of provisioning of the split rendering session. In some embodiments, the method can further comprise: determining that the AP has caused the edge server to run at least the portion of provisioning of the split rendering services for the split rendering session; and providing, from the RTC-AF, to the AP, an indication that the split rendering session is to be un-provisioned. In some embodiments, the method can further comprise: determining one or more characteristics of the current and new split rendering servers; determining, based at least on the one or more characteristics of the current and new split rendering servers, a time for completion of relocation of the split rendering session from the current split rendering server to the new split rendering server; and sending, to the current split rendering server and the new split rendering server, an indication that the new split rendering server is to relocate the split rendering session from the current split rendering server to the new split rendering server by the time for completion of relocation of the split rendering session. In some embodiments, the sending of the indication comprises sending an indication of the time for completion of relocation of the split rendering session relative to an XR runtime or relative to a relocation frame identifier indicating a particular frame from a sequence of frames in the XR media content stream by which time the relocation of the split rendering session is to be completed.

According to a seventh aspect, an apparatus can be provided that comprises means, such as at least one processor, and/or means such as at least one memory storing instructions, such as computer-readable instructions and/or instructions embodied as computer program code(s). In some embodiments, the apparatus can comprise means such as a real-time communication (RTC) application function (AF) in a core network (CN) or data network (DN) of a communication network, such as a fifth-generation (5G) communication network. In some embodiments, the apparatus can comprise means for monitoring, during a time period, one or more metrics associated with a split rendering session, the split rendering session being generated by a current split rendering server, wherein the split rendering session is associated with an extended reality (XR) media content stream being provided to a split rendering client by the current split rendering server, wherein the one or more metrics comprise one or more of: a quality of service (QOS) metric, a quality of experience (QoE) metric, a key performance indicator (KPI) of the current split rendering server, or a metric associated with the XR media content stream. In some embodiments, provisioning of split rendering servers for generating the split rendering session is managed by the RTC-AF. In some embodiments, the apparatus can comprise means for determining, based on a duration of occurrence of the one or more metrics exceeding a pre-determined duration threshold during the time period or a magnitude of the one or more metrics exceeding one or more respective pre-determined metric thresholds, to relocate the split rendering session from the current split rendering server to a new split rendering server. In some embodiments, the apparatus can comprise means for providing, to one or more of the current split rendering server or the new split rendering server, an indication to relocate the split rendering session from the current split rendering server to the new split rendering server. In some embodiments, the RTC-AF can be hosted in a session management function (SMF), a data server in a data network (DN), a policy control function (PCF), an access and mobility management function (AMF), NSSF, AUSF, UDM, NRF, UPF, and/or the like,

In some embodiments, the QoS metric is selected from among: a packet loss rate, a bit rate, a bandwidth, a latency, a variance in latency, a throughput, a transmission delay, an availability, or a jitter. In some embodiments, the apparatus can further comprise: means for requesting establishment of a new WebRTC session between the new split rendering server and the apparatus. In some embodiments, the apparatus can further comprise: means for providing, to the split rendering client, an indication that a relocation procedure has been initiated. In some embodiments, the apparatus can further comprise: means for including, in the indication to the split rendering client that a relocation procedure has been initiated, a request for the split rendering client to provide subsequent pose information and user input information to both the current split rendering server and the new split rendering server. In some embodiments, the apparatus can further comprise: means for sending, to one of the current split rendering server or the new split rendering server, a request to send, to the split rendering client, an indication that the split rendering session will be relocated from the current split rendering server to the new split rendering server. In some embodiments, the apparatus can further comprise: means for receiving, from the current split rendering server, first XR media content for a first viewport associated with the XR media content stream; receiving, from the new split rendering server, second XR media content for the first viewport associated with the XR media content stream; and determining, based on the first XR media content and the second XR media content, to relocate the split rendering session from the current split rendering server to the new split rendering server. In some embodiments, the apparatus can further comprise: means for indicating, to an application provider (AP) in the communication network, that the split rendering session will be relocated from the current split rendering server to the new split rendering server. In some embodiments, the apparatus can further comprise: means for requesting that an edge server in the communication network run at least a portion of provisioning of the split rendering session. In some embodiments, the apparatus can further comprise: means for determining that the AP has caused the edge server to run at least the portion of provisioning of the split rendering services for the split rendering session; and means for providing, to the AP, an indication that the split rendering session is to be un-provisioned. In some embodiments, the apparatus can further comprise: means for determining one or more characteristics of the current and new split rendering servers; means for determining, based at least on the one or more characteristics of the current and new split rendering servers, a time for completion of relocation of the split rendering session from the current split rendering server to the new split rendering server; and means for sending, to the current split rendering server and the new split rendering server, an indication that the new split rendering server is to relocate the split rendering session from the current split rendering server to the new split rendering server by the time for completion of relocation of the split rendering session. In some embodiments, the sending of the indication comprises sending an indication of the time for completion of relocation of the split rendering session relative to an XR runtime or relative to a relocation frame identifier indicating a particular frame from a sequence of frames in the XR media content stream by which time the relocation of the split rendering session is to be completed.

### BRIEF DESCRIPTION OF THE DRAWINGS

Having thus described embodiments of the disclosure in general terms, reference will now be made to the accompanying drawings, which are not necessarily drawn to scale, and wherein:

FIG. 1 illustrates an example architecture for a communications network, according to an embodiment;

FIG. 2 illustrates an example architecture for a communications network, according to an embodiment;

FIG. 3 illustrates an example architecture for a communications network, according to an embodiment;

FIG. 4 illustrates an example core network apparatus for facilitating seamless split rendering session relocation between split rendering servers in an edge server network in response to degraded viewport quality, according to an embodiment;

FIG. 5 illustrates an example an apparatus for facilitating seamless split rendering session relocation between split rendering servers in an edge server network in response to degraded viewport quality, according to an embodiment;

FIG. 6 illustrates an example apparatus configured to function or operate as a real-time communications application function (RTC-AF), according to an embodiment;

FIG. 7A illustrates a user device and a reference system for tracking user movements and adjusting viewport based thereon, according to an embodiment;

FIG. 7B illustrates a coordinate system associated with the reference system that is used to adjust a viewport of a virtual landscape for immersive media content based on pose information and sensor data from a user device, according to an embodiment;

FIG. 8 illustrates an example system architecture for viewport independent delivery of XR media, according to an embodiment;

FIG. 9 illustrates an example system architecture for viewport dependent delivery of XR media, according to an embodiment;

FIG. 10 illustrates an example system architecture for viewport rendering in a network, according to an embodiment;

FIG. 11 illustrates an example system architecture for raster-based split rendering of viewport-specific XR media, according to an embodiment;

FIG. 12 illustrates an example system architecture for split rendering of XR media, according to an embodiment;

FIG. 13 illustrates an example system architecture for distributed computing for delivery of viewport-specific XR media content, according to an embodiment;

FIG. 14 illustrates example messaging between a user equipment and network entities for seamless split rendering session monitoring and relocation, according to an embodiment;

FIG. 15 illustrates example messaging between a user equipment and network entities for seamless split rendering session monitoring and relocation, according to an embodiment;

FIG. 16 illustrates example messaging between a split rendering client and network entities for seamless split rendering session monitoring and relocation, according to an embodiment;

FIG. 17 illustrates example messaging between a split rendering client and a split rendering server via a SWAP server for seamless split rendering session monitoring and relocation, according to an embodiment;

FIG. 18 illustrates an example flow chart illustrating operations performed for facilitating seamless split rendering session relocation between split rendering servers, such as by the apparatus of one of FIGS. 4-6 or FIG. 5, according to an embodiment;

FIG. 19 is an example flow chart illustrating operations performed for facilitating seamless split rendering session relocation between split rendering servers, such as by the apparatus of one of FIGS. 4-6, according to an embodiment;

FIG. 20 is an example flow chart illustrating operations performed for facilitating seamless split rendering session relocation between split rendering servers, such as by the apparatus of one of FIGS. 4-6, according to an embodiment;

FIG. 21 is an example flow chart illustrating operations performed for facilitating seamless split rendering session relocation between split rendering servers, such as by the apparatus of one of FIGS. 4-6, according to an embodiment;

FIG. 22 is an example flow chart illustrating operations performed for facilitating seamless split rendering session relocation between split rendering servers, such as by the apparatus of one of FIGS. 4-6, according to an embodiment;

FIG. 23 is an example flow chart illustrating operations performed for facilitating seamless split rendering session relocation between split rendering servers, such as by the apparatus of one of FIGS. 4-6, according to an embodiment; and

FIG. 24 is an example flow chart illustrating operations performed for facilitating seamless split rendering session relocation between split rendering servers, such as by the apparatus of one of FIGS. 4-6, according to an embodiment.

### SYMBOLS AND ABBREVIATIONS

As used the present disclosure and in technical specifications incorporated herein by reference in their entireties, the following symbols and abbreviations are defined as follows:
α a yaw of a split rendering client device (e.g., user device) in a Third-Generation Partnership Project (3GPP) 3 Degrees of Freedom (3DOF) coordinate system
β a pitch of a split rendering client device (e.g., user device) in a 3GPP 3DOF coordinate system
γ a roll of a split rendering client device (e.g., user device) in a 3GPP 3DOF coordinate system
ϕ an azimuth of a split rendering client device (e.g., user device) in a 3GPP 3DOF coordinate system
θ an elevation of a split rendering client device (e.g., user device) in a 3GPP 3DOF coordinate system
3DOF 3 Degrees of freedom
5G-RTC 5G Real-Time Communication
ACN Ambisonics Channel Number
AF Application Function
API Application Programming Interface
AS Application Server
AVC Advanced Video Coding
BMFF Base Media File Format
BRIR Binaural Room Impulse Response
CMP Cube-Map Projection
CIBR Common Informative Binaural Renderer
DASH Dynamic Adaptive Streaming over HTTP
DRC Dynamic Range Control
EOTF Electro-Optical Transfer Function
ERP EquiRectangular Projection
ESD Equivalent Spatial Domain
FFT Fast Fourier Transform
FIR Finite Impulse Response
FOA First Order Ambisonics
FOV Field Of View
GPU Graphics Processing Unit
HDR High Dynamic Range
HDTV High Definition Tele Vision
HEVC High Efficiency Video Coding
HMD Head Mounted Display
HOA High Order Ambisonics
HRD Hypothetical Reference Decoder
HRIR Head-Related Impulse Responses
HRTF Head-Related Transfer Function
HTTP HyperText Transfer Protocol
IFFT Inverse FFT
IRFFT Inverse RFFT
MAE MPEG-H Audio Metadata information
MAF Media Access Function
MCC Metrics Collection and Computation
MHAS MPEG-H Audio Stream
MIME Multipurpose Internet Mail Extensions
MPD Media Presentation Description
MPEG Moving Pictures Experts Group
MSH Media Session Handler
NAL Network Abstraction Layer
OMAF Omnidirectional MediA Format
PCM Pulse Code Modulation
RAP Random Access Point
RFFT Real FFT
RWP Region-Wise Packing
SDR Standard Dynamic Range
SEI Supplemental Enhancement Information
SN3D Schmidt semi-normalization
SOFA Spatially Oriented Format for Acoustics
SPS Sequence Parameter Set
SR Split Rendering
SRC Split Rendering Client
SRQR Spherical Region-wise Quality Ranking
SRS Split Rendering Server
UE User Equipment
VCL Video Coding Layer
VST Virtual Studio Technology
VUI Video Usability Information
VR Virtual Reality

### DETAILED DESCRIPTION

Mobile telecommunication services rely on a continuous connection to a communication network to work properly and take advantage of the full service. To ensure the continuous connection, a communication device operating consuming a service of the communication network monitors a connection quality and regularly transmits, to a base station of the communication network, measurement reports comprising measurements related to the quality of the connection (e.g., the quality of a connection with a base station of a radio access network of the communication network). In the event of a drop in quality of the connection, e.g. due to movement of the communication device out of a coverage area of a base station, the communication network supports a handover of the communication device to another base station to maintain quality of the connection (e.g., the radio connection) with the communication network.

For new generations of mobile communication networks such as 5G networks currently under standardization by the 3rd Generation Partnership Project (3GPP), virtual reality applications executed by the mobile stations are to be supported, as specified e.g. by 3GPP TR 26.928, version 16.1.0, version 17.0.0, and 18.0.0, the entire disclosures of each of which are hereby incorporated herein by reference in their entireties for all purposes. Among these applications, extended Reality (XR) and Cloud Gaming are some of the most important 5G media applications under consideration in the industry. XR is an umbrella term for different types of realities and refers to all real-and-virtual combined environments and human-machine interactions generated by computer technology and wearables. Different application domains of XR Applications include entertainment, healthcare, education, etc.

Third-Generation Partnership Project (3GPP) Technical Specification (TS) 23.558, the entire disclosure of which is hereby incorporated herein by reference in its entirety for all purposes, defines architectural solutions for enabling Edge applications. The term ‘Edge application’ refers to user applications which are supported and hosted by server elements of particular networks, which are a part of the overall communication network referred to as an Edge network. Edge networks, also known as Edge Data Networks (EDN), are typically logically located between a core network [CN] of the communication network, a Cloud Data Network, and UEs. In some embodiments, an EDN may contain Edge Application Server(s) (EAS) and/or an Edge Enabler Server (EES). In some embodiments, operation of the EES may be supported by an Edge Configuration Server (ECS). The EDN that includes EAS(s) and/or EES(s) may also include EDGE-X interfaces to communicate with the servers of the network. The UE may contain an application client, which has the task for the proper execution of an MR application, AR application, VR application and/or XR application, and an Edge Enabler Client (EEC) as an interface to communicate with EDN network servers. More details about the EDN architecture and operation is disclosed in 3GPP TS 26.558, version 18.3.0, the entire disclosure of which is hereby incorporated herein by reference in its entirety for all purposes.

The EAS is the application server resident in the Edge Data Network, performing the server functions and is connected to the 3GPP core via Radio Access Network (RAN). The EES facilitates context transfer between EES(s) and EAS(s) and interacts with the 3GPP core either directly (e.g. via PCF) or indirectly (e.g. via SCEF, NEF, and/or SCEF+NEF). Additionally, the EES provides configuration information to Edge Enabler Client enabling exchange of application data traffic with the EAS. The ECS provides supporting functions needed for the Edge Enabler Client to connect with an EES. Additionally, the ECS supports the EES in identifying other EESs (and EASs) in case of application relocations. Furthermore, EDGE-9 symbolizes the connection to another EDN. In case of a relocation from one EAS to another, EDGE-9 is the connection from a source EES to a target EES.

Time-critical communications is a concept in communication networks and protocols, such as in 5G, 6G, and other technologies, for enabling services with reliable low latency requirements such as XR, which encompasses various immersive technologies, such as Virtual Reality (VR), Mixed Reality (MR), and Augmented Reality (AR). In VR, users are totally immersed in a simulated digital environment or a digital replica of reality. MR encompasses all forms of technology that blend virtual elements with real-world surroundings. AR overlays digital information onto real-life images observed through a device.

XR connectivity requirements depend on the level of split architecture and the targeted Quality of Experience (QoE), leading to a wide range of bit rates and strict latency requirements. To ensure XR applications work well over 5G networks, low-latency, high-quality is important. When the XR device is not powerful enough to achieve performance indicators like required data rate and latency, offloading of some processing tasks to the cloud (cloud edge server) is carried out. This process is called split rendering. Split rendering systems may divide rendering of XR content such as VR or AR content between a server and a client. XR systems may implement split rendering in which the workload is split between multiple components such as, such as an XR device and Split Rendering Server (SRS). Most frequently, computation-intensive tasks like rendering are executed on SRS. SRS can be a cloud render server as well as an edge render server. The XR device can communicate with the SRS through the network which can be 3GPP Radio Access Technology (RAT), and/or non-3GPP RAT.

In XR, VR, AR, and MR viewing environments, visual media content is generated for display at the user device, which can include a heads-up display or head-mounted display (HMD), or the like. The user device and/or display device (also referred to herein as a ‘split rendering client’) can be divided into sections or portions of 360 degrees of viewing perspective, which can be referred to as viewports, such that the visual media content can be generated for one or more viewports such that the rendered visual media content corresponds to a field of view (FOV) of the eyes of a user viewing the media content, inclusive of a stereoscopic offset to simulate natural parallax. As used herein, the term ‘viewport’ refers to a portion of the XR content to be rendered for a user based on pose information associated with the user and the user's associated field of view (FOV) within the full virtual scene, of which only the portion designated as the viewport during an associated time is being rendered.

The rendered viewport can then be adjusted in real-time based on changes in a user's perceived location, viewing direction, head movements, rate of change of movement of these characteristics, and other user movements or behaviors. To do this, the user device can track its own pose and movement based on a variety of sensors, gyroscopes, magnetometers, accelerometers, and/or the like, and the user device can then receive a full complement of rendered raw visual media content for the entire virtual environment being viewed and experienced by the user, and then the user device can clip the user motion and pose adjusted viewport from the raw visual media content. However, such a solution requires the transmission of an unacceptably large amount of rendered visual media content, requires that the user device has exceedingly high computational capabilities, and incurs significant latency due to all rendering activities being carried out at the user device prior to display of the viewport during each associated period of time. The exceedingly high computational capabilities requirements, however, mean that the user device (e.g., virtual reality goggles, augmented reality glasses, heads-up display, head-mounted display, or the like) will be bulky and heavy due to increased battery capacity requirements, which will crode the immersiveness of the user experience, and will require processing chips and graphics cards having higher processing capacity, which increases the cost of the user device.

In order to reduce the need for computational capacity at the user device, reduce the cost of user devices, and reduce bandwidth requirements, the computational cost and latency cost of rendering the XR media content can be shared between the user device and one or more other devices. Split rendering sharing can be used to alleviate the XR media content rendering required to be carried out by the user device and reduce the latency of between the user's movements and the corresponding changes in the XR scene. The primary goal of split rendering is to reduce the latency between the user's movements and the corresponding changes in the XR scene. This latency, often referred to as motion-to-photon latency, can cause discomfort and reduce the sense of immersion for a user. Split rendering addresses this by minimizing the time it takes to generate and display each frame of the XR media content. Additional detail regarding split rendering is provided in 3GPP TS 26.565, version 0.5.0, the entire contents of which are hereby incorporated herein by reference in its entirety for all purposes.

The XR application's rendering pipeline generates a stereo pair of images, called eye buffers, one for each eye, based on the virtual scene and the user's pose. The pose data is sent to the compositor, which uses this information to generate a warp mesh for each eye. The warp mesh corrects any discrepancies between the rendered image and the actual display output due to the user's movements. The compositor takes the eye buffers and applies lens distortion correction and warp adjustments based on the warp mesh. Once the image is corrected based on user movements and pose information, the corrected image is known as a warped frame. The compositor's output, the warped frame, is sent to the user device for display to the user. By using a compositor and split rendering services, the user device can achieve very low latency and minimize the motion-to-photon latency.

By offloading the warp and lens correction computations to a separate compositor, the GPU's workload is reduced, leading to improved rendering performance. The split rendering approach means that the final image displayed to the user is correctly aligned with their perspective, even if there are slight discrepancies due to rapid head movements or changes in the user's pose.

In the XR context, split rendering sessions are facilitated by provisioning a compositor, such as a split rendering server, to carry out split rendering services for a user device. However, over time, a compositor, such as a split rendering server, can become overburdened, resource starved, or otherwise experience a reduction in rendering capacity, which can lead to a degradation in quality of the rendered visual media content.

Edge server provisioning for split rendering session services is often used to deliver high-quality extended reality (XR) experiences, particularly in scenarios where the rendering workload is distributed between different devices or subsystems. This provisioning involves setting up and managing servers at the edge of the network, closer to the end-users, to ensure low latency, efficient data transfer, and smooth communication between the XR devices, rendering hardware, and compositor.

The present disclosure addresses the lack of procedures for seamless offloading of split rendering tasks to split rendering servers under certain challenging scenarios. In the current state of technology, client-driven split rendering procedures are available that can operate well in reliable communication networks. When technical issues with edge server infrastructures (e.g., power outages, disaster recovery situations) and network congestion (e.g., audience spikes or localized congestion) are encountered, the offloading process may be degraded. In such cases, seamless and automation of XR split rendering session relocation is required. Further, relocating the session solely on the server side would result in service interruption and a drop in quality of experience (QoE) for the user.

However, there are not currently sufficient processes or methods in the relevant 3GPP standards or elsewhere for handling edge server location and distribution, XR server network connectivity issues, split rendering load balancing and scaling, split rendering session management, split rendering server provisioning and deprovisioning, data transfer and compression, and other aspects of XR split rendering.

Also, in practical deployments of split rendering services over edge servers, there are cases where a split rendering session may need to be relocated for reasons that are independent from the split rendering client (e.g., user device), and that the split rendering client cannot detect and/or about which the split rendering client is not made aware. As mentioned above, handling of split rendering session relocation entirely on the server side creates service interruptions and a degradation of QoE for the user if not carried out in cooperation with already established split rendering session(s). Currently, at the application-level (e.g., end-to-end), split rendering session mobility is agnostic to user device handover between different access nodes (e.g., radio access network [RAN], gNodeB [gNB], etc.) and provides no mechanism for monitoring for XR media content quality degradation, network traffic degradation, QoS metric degradation, QoE metric degradation, server KPI degradation during XR split rendering, nor are any mechanisms in place for how to relocate split rendering sessions when such degradation occurs.

The term QoS is used herein to refer to performance characteristics of a network service, and is usually used to assure that the network performs at or above certain levels of quality. QOS metrics can be selected from among: a packet loss rate (which refers to the percentage of packets that are sent from a source device to a destination device but do not arrive), a bit rate, a bandwidth, a latency (which is the amount of time it takes for a packet to travel from a source to a destination), a throughput, a transmission delay, an availability, a jitter (a variance in packet latency over time), bandwidth allocation (which may be used to ensure that adequate bandwidth is allocated to data flows), and/or the like.

The term QoE is used herein to refer to measures of a customer's experience with a network service and is typically more user-centric. QoE metrics can be selected from among: user satisfaction (which measures how delivered content or a network service meets user's expectations), perceptual quality (which is based on subjective opinions of users about the delivered content or network service), accessibility (which refers to the case with which users can access the delivered content or network service), reliability (which refers to how often a delivered content stream or network service are available to the user device and/or user without interruption), and/or the like.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be examples and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

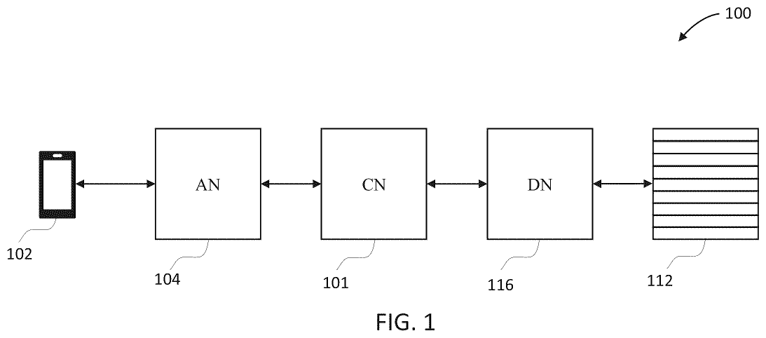

In the following, certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIG. 1-3 to assist in understanding the technology underlying the described examples.

According to some embodiments, a communication device or terminal can be provided for wireless access via cells, base stations or similar wireless transmitter and/or receiver nodes, providing access points for a radio access system.

Access points and hence communications there through are typically controlled by at least one appropriate controller apparatus so as to enable operation thereof and management of mobile communication devices in communication therewith. In some embodiments, a control apparatus for a node may be integrated with, coupled to and/or otherwise provided for controlling the access points. In some embodiments, the control apparatus can be arranged to allow communications between a user equipment and a core network or a network entity of the core network. For this purpose, the control apparatus may comprises at least one memory, at least one data processing unit such as a processor or the like, and an input and/or output interface. Via the interface, the control apparatus can be coupled to relevant other components of the access point. The control apparatus can be configured to execute an appropriate software code to provide the control functions. It shall be appreciated that similar components can be provided in a control apparatus provided elsewhere in the network system, for example in a core network entity. The control apparatus can be interconnected with other control entities. The control apparatus and functions may be distributed between several control units. In some embodiments, each base station can comprise a control apparatus. In alternative embodiments, two or more base stations may share a control apparatus.

Access points and associated controllers may communicate with each other via a fixed line connection and/or via a radio interface. The logical connection between the base station nodes can be provided for example by an X2 or the like interface. This interface can be used for example for coordination of operation of the stations and performing reselection or handover operations.

The communication device or user equipment may comprise any suitable device capable of at least receiving wireless communication of data. For example, the device can be handheld data processing device equipped with radio receiver, data processing and user interface apparatus. Non-limiting examples include a mobile station (MS) such as a mobile phone or what is known as a ‘smart phone’, a portable computer such as a laptop or a tablet computer provided with a wireless interface card or other wireless interface facility, personal data assistant (PDA) provided with wireless communication capabilities, or any combinations of these or the like. Further examples include wearable wireless devices such as those integrated with watches or smart watches, eyewear, helmets, hats, clothing, car pieces with wireless connectivity, jewelry and so on, universal serial bus (USB) sticks with wireless capabilities, modem data cards, machine type devices or any combinations of these or the like.

In some embodiments, a communication device, e.g., configured for communication with the wireless network or a core network entity, may be exemplified by a handheld or otherwise mobile communication device (or user equipment UE). A mobile communication device may be provided with wireless communication capabilities and appropriate electronic control apparatus for enabling operation thereof. Thus, the communication device may be provided with at least one data processing entity, for example a central processing unit and/or a core processor, at least one memory and other possible components such as additional processors and memories for use in software and hardware aided execution of tasks it is designed to perform. The data processing, storage and other relevant control apparatus can be provided on an appropriate circuit board and/or in chipsets. Data processing and memory functions provided by the control apparatus of the communication device are configured to cause control and signaling operations in accordance with certain embodiments as described later in this description. A user may control the operation of the communication device by means of a suitable user interface such as touch sensitive display screen or pad and/or a key pad, one of more actuator buttons, voice commands, combinations of these, or the like. A speaker and a microphone are also typically provided. Furthermore, a mobile communication device may comprise appropriate connectors (either wired or wireless) to other devices and/or for connecting external accessories, for example hands-free equipment, thereto.

In some embodiments, a communication device may communicate wirelessly via appropriate apparatus for receiving and transmitting signals. In some embodiments, a radio unit may be connected to the control apparatus of the device. The radio unit can comprise a radio part and associated antenna arrangement. The antenna arrangement may be arranged internally or externally to the communication device.

FIGS. 1-3 illustrate various exemplary architectures for a communications network 100 in which the various methods, apparatuses, and computer program products can be carried out and/or used. In some embodiments, the communications network 100 can comprise any suitable configuration, number, orientation, positioning, and/or dimensions of components and specialized equipment configured to provide air interface (e.g., New Radio (NR)) communication or connection between a user equipment 102 (UE 102) and a data network 116 (DN 116) via a core network 101 (CN 101) of the communications network 100. As illustrated in FIG. 1, a communications network 100 may be provided in which the UE 102 is in operable communication with the AN 104, such as by way of a transmission tower, a base station, a network node, or the like. In some embodiments, the AN 104 can communicate with the CN 101 or a component or entity thereof. In some embodiments, the CN 101 can facilitate communication between the UE 102 and the DN 116, such as for sending data, messages, requests, or the like. In some embodiments, the DN 116 or the CN 101 can be in communication with an application server or application function 112 (AS/AF 112).

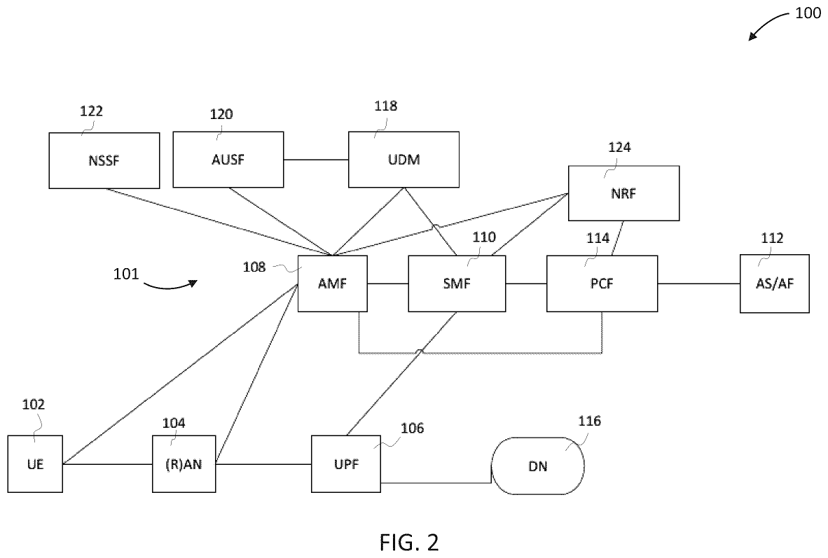

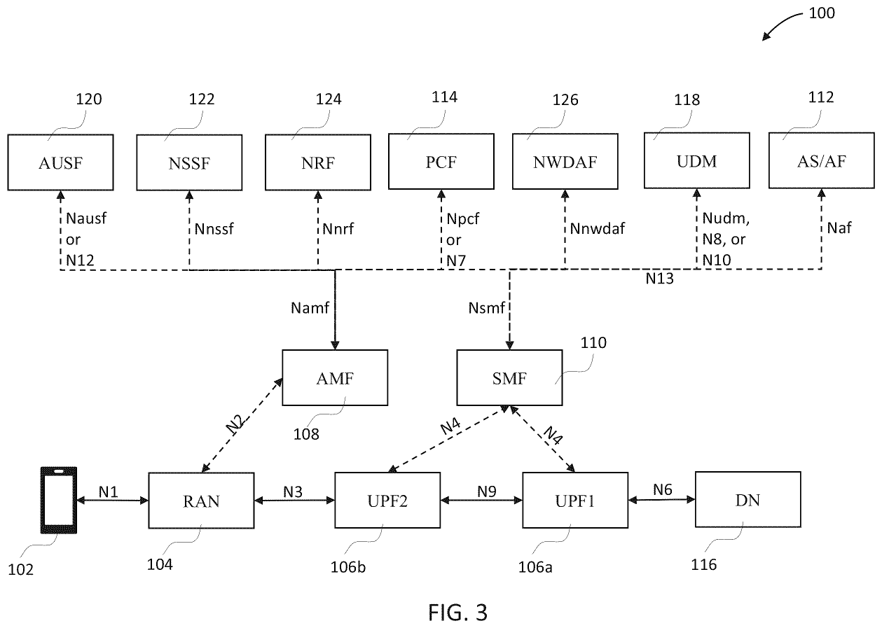

In the context of a fifth-generation (5G) network, such as illustrated in FIGS. 2 and 3, the communications network 100 may comprise a series of connected network devices and specialized hardware that is distributed throughout a service region or country, and one or more network entities, which may be stored at and/or hosted by one or more of the connected network devices or specialized hardware. In some embodiments, the UE 102 may connect to the AN 104, which can then relay the communications between the UE 102 and the CN 101, the CN 101 being connected to the DN 116, which may be in communication with one or more AS/AF 112. In some embodiments, the UE 102 may be in communication with a radio access network 104 (RAN 104 or (R)AN 104), which may act as a relay between the UE 102 and other components or services of the CN 101. For instance, in some embodiments, the UE 102 may communicate with the RAN 104, which may in turn communicate with an Access and Mobility Management Function 108 (AMF 108). In other instance or embodiments, the UE 102 may communicate directly with the AMF 108. In some embodiments, the AMF 108 may be in communication with one or more network functions (NFs), such as an Authentication Server Function 120 (AUSF 120), a Network Slice Selection Function 122 (NSSF 122), a Network Repository Function 124 (NRF 124), a Policy Charging Function 114 (PCF 114), a Network Data Analytics Function 126 (NWDAF 126), a Unified Data Management function 118 (UDM 118), the AS/AF 112, a Session Management Function 110 (SMF 110), and/or the like.

In some embodiments, such as illustrated in FIG. 3, the SMF 110 may be in communication with one or more User Plane Functions 106 (UPF 106, UPF 106a, UPF 106b, collectively “UPF 106”). By way of example only, in some embodiments, the UPF 106 may be in communication with the RAN 104 and the DN 116. In other embodiments, the DN 116 may be in communication with a first UPF 106a and the RAN 104 may be in communication with a second UPF 106b, while the SMF 110 is in communication with both the first and second UPFs 106a, b and the first and second UPFs 106a, b are in communication each with the other.

In some embodiments, the UE 102 can comprise a single-mode or a dual-mode device such that the UE 102 can be connected to one or more RANs 104. In some embodiments, the RAN 104 may be configured to implement one or more radio access technologies (RATs), such as Bluetooth, Wi-Fi, and GSM, UMTS, LTE or 5G NR, among others, that can be used to connect the UE 102 to the CN 101. In some embodiments, the RAN 104 can comprise or be implemented using a chip, such as a silicon chip, in the UE 102 that can be paired with or otherwise recognized by a similar chip in the CN 101, such that the RAN 104 can establish a connection or line of communication between the UE 102 and the CN 101 by identifying and pairing the chip within the UE 102 with the chip within the CN 101. In some embodiments, the RAN 104 can implement one or more base stations, towers or the like to communicate between the UE 102 and the AMF 108 of the CN 101.

In some embodiments, the communications network 100 or components thereof (e.g., base stations, towers, etc.) can be configured to communicate with a communication device (e.g., the UE 102) such as a cell phone or the like over multiple different frequency bands, e.g., FR1 (below 6 GHZ), FR2 (mmWave), other suitable frequency bands, sub-bands thereof, and/or the like. In some embodiments, the communications network 100 can comprise or employ massive multiple input and multiple output (massive MIMO) antennas. In some embodiments, the communications network 100 can comprise multi-user MIMO (MU-MIMO) antennas. In some embodiments, the communications network 100 can employ edge computing whereby the computing servers are communicatively, physically, computationally, and/or temporally closer to the communications device (e.g., UE 102) in order to reduce latency and data traffic congestion. In some embodiments, the communications network 100 can employ other technologies, device, or techniques, such as small cell, low-powered RAN, beamforming of radio waves, WiFi-cellular convergence, non-orthogonal multiple access (NOMA), channel coding, and the like.

As illustrated in FIG. 3, the UE 102 may be configured to communicate with the RAN 104 in a N1 interface, e.g., according to a non-access stratum (NAS) protocol. In some embodiments, RAN 104 can be configured to communicate with the CN 101 or a component thereof (e.g., the AMF 108) in a N2 interface, e.g., in a control plane between a base station of the RAN 104 and the AMF 108. In some embodiments, the RAN 104 can be configured to communicate with the UPF 106 in a N3 interface, e.g., in a user plane. In some embodiments, the AMF 108 and/or the SMF 110 can be configured to communicate with other services or network entities within the CN 101 in various different interfaces and/or according to various different protocols. For instance, in some embodiments, the AMF 108 and/or the SMF 110 can be configured to communicate with the AUSF 120 in a Nausf interface or an N12 interface. In some embodiments, the AMF 108 and/or the SMF 110 can be configured to communicate with the NSSF 122 in a Nnssf interface. In some embodiments, the AMF 108 and/or the SMF 110 can be configured to communicate with the NRF 124 in a Nnrf interface. In some embodiments, the AMF 108 and/or the SMF 110 can be configured to communicate with the PCF 114 in a Npcf interface or an N7 interface. In some embodiments, the AMF 108 and/or the SMF 110 can be configured to communicate with the NWDAF 126 in a Nnwdaf interface. In some embodiments, the AMF 108 and/or the SMF 110 can be configured to communicate with the UDM 118 in a Nudm interface, an N8 interface, or an N10 interface. In some embodiments, the AMF 108 and/or the SMF 110 can be configured to communicate with the AS/AF 112 in a Naf interface. In some embodiments, the SMF 110 can be configured to communicate with the UPF 106 in a N4 interface, which may act as a bridge between the control plane and the user plane, such as acting as a conduit for a Protocol Data Unit (PDU) session during which information is transmitted between, e.g., the UE 102 and the CN 101 or components and/or services thereof.

It will be appreciated that example embodiments of the invention disclosed and/or otherwise described herein arise in the context of a telecommunications network, including but not limited to a telecommunications network that conforms to and/or otherwise incorporates aspects of a fifth-generation (5G) architecture. While FIGS. 1-3 illustrate various configurations and/or components of an exemplary architecture of the mobile communication network 100 (generally referred to as network 100 herein), many other systems, system configurations, networks, network entities, and pathways and/or protocols for communication therein are contemplated and considered within the scope of this present disclosure.

While the methods, devices, and computer program products described herein are described within the context of a fifth-generation (5G) core network and system, such as illustrated in FIGS. 1-3 and described hereinabove, the described methods, devices, and computer program products can nevertheless be applied in a broader context within any suitable telecommunications system, network, standard, or protocol.

Aspects of the present disclosure introduce procedures for effectively managing split rendering session transitions during relocation. The disclosed approach includes, in some embodiments, monitoring for existing split rendering sessions and triggering relocation based on monitoring of media session degradation. This may lead to uninterrupted offloading in dynamic scenarios. Based on the relocation trigger result from monitoring, split rendering can be relocated or provisioned to a new server, and split rendering sessions can be efficiently transferred to a new server. Further negotiation between the two split rendering sessions, based on timing information, can facilitate seamless switching during relocation of a split rendering session. Further, extensions to the SplitRenderingConfiguration resource, along with the addition of a new application-specific message for split rendering transfer format, providing essential relocation information, are described.

3GPP TR 26.928 defines the terms Virtual Reality (VR), Augmented Reality (AR), Mixed Reality (MR), and extended Reality (XR) are defined as follows:

Virtual reality (VR) is a rendered version of a delivered visual and audio scene. The rendering is designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually employed to allow the simulated visual and audio components to be updated in order to ensure that, from the user's perspective, items and sound sources remain consistent with the user's movements. Additional means to interact with the virtual reality simulation may be provided.

Augmented reality (AR) is when a user is provided with additional information or artificially generated items or content overlaid upon their current environment. Such additional information or content will usually be visual and/or audible and their observation of their current environment may be direct, with no intermediate sensing, processing and rendering, or indirect, where their perception of their environment is relayed via sensors and may be enhanced or processed.

Mixed reality (MR) is an advanced form of AR where some virtual elements are inserted into the physical scene with the intent to provide the illusion that these elements are part of the real scene.

Extended reality (XR) refers to all real-and-virtual combined environments and human-machine interactions generated by computer technology and wearables. XR includes representative forms such as AR, MR and VR and the areas interpolated among them. The levels of virtuality range from partially sensory inputs to fully immersive VR. A key aspect of XR is the extension of human experiences especially relating to the senses of existence (represented by VR) and the acquisition of cognition (represented by AR).

Likewise, the term XR is used herein as a superordinate category covering AR, MR and VR including purely virtual applications.

According to the descriptions of use cases of virtual reality applications such as XR applications given by 3GPP TR 22.842, version 17.2.0, the entire disclosure of which is hereby incorporated herein by reference in its entirety for all purposes, many of the XR applications are expected to be stateful, meaning that the applications have a state describing the UE application status at a certain point of time. Additionally, the fact that the UEs are expected to interact (e.g., in gaming applications) implies that the various UEs' states should be shared among the UEs. This introduces several challenges during a handover (HO) procedure:
a. The target gNB should be prepared and have adequate radio resources to accommodate the UE executing the XR application.
b. In case of a handover failure, the UE will experience service interruption, thus the network should try to ensure seamless handover (considering also application relocation) to avoid an interruption of the XR application.
c. In case of a User Plane Function (UPF) relocation, the new UPF may not be able to offer the XR service.
d. During the handover, the target EAS may not be properly prepared to take over the EAS functionalities from the previous EAS to avoid long delays.

The present disclosure addresses these challenges and generally relates to a handover in a communication network such as a mobile communication network, e.g. a 5G network. Note that the present disclosure relates to various types and generations of communication networks configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, cHRPD), etc.

The communication network is equipped with a plurality of base stations including a source base station and a target base station. The handing concerns a UE executing an XR application over a connection with the source base station. As used herein, the term “user equipment” may refer to any of various types of computer systems devices which are mobile or portable and which perform wireless communications. Examples of UEs include mobile telephones or smart phones, portable gaming devices, laptops, wearable devices (e.g., smart watch, smart glasses), Personal Digital Assistants (PDAs), portable Internet devices, music players, data storage devices, or other handheld devices, etc. In general, the term “UE” can be broadly defined to encompass any electronic, computing, and/or telecommunications device (or combination of devices) which is easily transported by a user and capable of wireless communication.

The present disclosure is particularly directed to enable the target base station (target gNodeB or gNB in 5G terminology) to support an XR application of the UE in terms of radio capabilities and regarding the resources at the Edge Data Network (EDN), as already introduced above. In embodiments, the target base station and the target EDN(s) are properly prepared to undertake the UE XR capabilities and the proper User Plane Function (UPF) is selected considering the XR capabilities of the Application Function (AF) regarding XR application aspects. Also, during handover, a proper UPF may be re-selected considering the XR capabilities of the target AF, also if the application were to be relocated during handover.

The split rendering mechanisms specified in 3GPP TS 26.565, version 0.5.0, are client driven. The split rendering client (e.g., UE 102) contacts an edge server and requests a list of available computing resources, possibly associated with a desired compute capacity (RAM, CPU, GPU, . . . ). The server returns a list of server uniform resource identifiers (URI) that match the resource request from the split rendering client. Then, the split rendering client can select a server from the list and offload some or all of the split rendering processing to the selected server.

However, the approach described in 3GPP TS 26.565, version 0.5.0 only works well when network conditions are static and when edge server resources are reliable. Network conditions, though, are rarely static and edge server resources are often unreliable; meaning that these and other factors can degrade the quality of XR media content output from the split rendering session and split rendering session offloading, such as:

Split rendering clients (e.g., UE 102) in mobility (triggering a handover from one access network and/or RAN to another), facing changing location and network conditions (e.g., travelling in a train, or switching from home network, i.e., Wi-Fi, to 3GPP RAT, etc.), split rendering server congestion, under-resourced server provisioning, edge server infrastructures experiencing technical problems which degrades reliability (e.g., electricity outage, disaster recovery, air conditioning issues, etc.), and when the network faces audience spikes, which typically reduces the QoS and creates geographically localized congestion.

In those cases, 3GPP TS 26.565, version 0.5.0 does not provide mechanisms for shifting the offload tasks to another edge server, or to tell the split rendering client to do so. Furthermore, when the offloading task is shifted, it is important to preserve session continuity in a seamless manner for the client, which is not addressed as well.

In order to address these and other problems with current systems and practices for split rendering session support, new call flows are added for split rendering relocation. A split rendering session for which rendering is being supported or fully handed by a current split rendering server is monitored, such as by an element of a mobile communication network (e.g., network 100) or network function of a core network. The monitoring can be carried out by a data network (e.g., DN 116), a RAN node, a session management function (e.g., SMF 110), or the like. The element of the network (e.g., DN 116) or network function (e.g., SMF 110) can monitor for QoS, such as by monitoring or measuring a packet loss rate, a bit rate, a bit error rate, a throughput, a transmission delays, an availability rate, a jitter, or the like. If the element of the network (e.g., DN 116) or network function (e.g., SMF 110) detects a deterioration of one or more QoE metrics and/or one or more QoS metrics, or otherwise determines that the split rendering session should be relocated from the current split rendering server, the element or function, SMF 110, etc.) can indicate the same to the current split rendering server, the split rendering client (e.g., UE 102), an application provider, a target split rendering server, a SWAP server, and/or the like (e.g., provide an indication that the split rendering session should be relocated from the current split rendering server to the split rendering client, an application provider, a target split render server, and/or a SWAP server).

In an instance in which the element of the network (e.g., DN 116) or network function SMF 110) determines that the split rendering session should be relocated away from the current split rendering server to another server, the element of the network or network function can then request the provisioning of the target split rendering server. The element (e.g., DN 116) or network function (e.g., SMF 110) can also indicate to the split rendering client (e.g., UE 102) that it is to provide pose and movement information to both (1) the current split rendering server as it has already been doing during the time that the current split rendering server has been provide split rendering services to the split rendering client, and (2) the target split rendering server. The element of the network (e.g., DN 116) or network function (e.g., SMF 110) can then indicate to the target split rendering server that it is to receive pose and movement information from the split rendering client (e.g., UE 102) and render a second split rendering session in parallel with the current split rendering session being rendered by the current split rendering server. After the split rendering client sends the pose and movement information to both the current and target split rendering servers, the current split rendering server renders viewport-specific XR visual media content and sends the rendered viewport-specific XR visual media content to split rendering client (e.g., UE 102), while at the same time the target split rendering server renders the same viewport-specific XR visual media content and sends the rendered viewport-specific XR visual media content and/or information about the rendered viewport-specific XR visual media content to the element of the network (e.g., DN 116) or network function (e.g., SMF 110) in the mobile communication network (e.g., network 100).

Examples of pose information that can be transmitted from the split rendering client (e.g., UE 102) to one or more split rendering servers are illustrated below in Table 1.

TABLE 1

| Name | Type | Cardinality | Description |
|---|---|---|---|
| poseInfo | Object | 1 . . . n | An array of pose information objects, each |
| | | | corresponding to a target display time and XR |
| | | | space. |
| displayTime | Number | 1 . . . 1 | The time for which the current view poses are |
| | | | predicted. |
| xrSpace | Number | 0 . . . 1 | An identifier for the XR space in which the view |
| | | | poses are expressed. The set of XR spaces are |
| | | | agreed on between the split rendering client and |
| | | | the split rendering server at the setup of the split |
| | | | rendering session. |
| viewPoses | Object | 0 . . . n | The set of XR spaces is negotiated as part of the |
| | | | split rendering configuration as defined in clause |
| | | | 8.4.2.2. |
| pose | Object | 1 . . . 1 | An array that provides a list of the poses |
| | | | associated with every view. The number of views |
| | | | is determined during the split rendering session |
| | | | setup between the split rendering client and server, |
| | | | depending on the view configuration of the XR |
| | | | session. |
| orientation | Object | 1 . . . 1 | An object that carries the pose information for a |
| | | | particular view. |
| x | Number | 1 . . . 1 | Represents the orientation of the view pose as a |
| | | | quaternion based on the reference XR space. |
| y | Number | 1 . . . 1 | Provides the x coordinate of the quaternion. |
| z | Number | 1 . . . 1 | Provides the y coordinate of the quaternion. |
| w | Number | 1 . . . 1 | Provides the z coordinate of the quaternion. |
| position | Object | 1 . . . 1 | Provides the w coordinate of the quaternion. |
| x | Number | 1 . . . 1 | Represents the location in 3D space of the pose |
| | | | based on the reference XR space. |
| y | Number | 1 . . . 1 | Provides the x coordinate of the position vector. |
| z | Number | 1 . . . 1 | Provides the y coordinate of the position vector. |
| fov | Object | 1 . . . 1 | Provides the z coordinate of the position vector. |
| angleLeft | Number | 1 . . . 1 | Indicates the four sides of the field of view used |
| | | | for the projection of the corresponding XR view. |
| angleRight | Number | 1 . . . 1 | The angle of the left side of the field of view. For |
| | | | a symmetric field of view this value is negative. |
| angleUp | Number | 1 . . . 1 | The angle of the right side of the field of view. |
| angleDown | Number | 1 . . . 1 | The angle of the top part of the field of view. |

Further detail about the pose information and format can be found in 3GPP TS 26.565, version 0.5.0, the entire contents of which are hereby incorporated herein by reference in its entirety for all purposes.

The element or network function (e.g., DN 116, SMF 110, etc.) in the mobile communication network (e.g., network 100) receives the rendered viewport-specific XR visual media content or the information about the rendered viewport-specific XR visual media content from the target split rendering server, and determines from that content or information provided by the target split rendering server one or more QoS metrics and/or QoE metrics for the rendered viewport-specific XR visual media content from the target split rendering server. The one or more QOS metrics and/or QoE metrics for the rendered viewport-specific XR visual media content from the target split rendering server can be compared by the element or function against a predetermined threshold or baseline, and/or against comparable QoS metrics and/or QoE metrics for the rendered viewport-specific XR visual media content from the source split rendering server. Accordingly, the element or function (e.g., DN 116, SMF 110, etc.) in the mobile communication network (e.g., network 100) can determine whether the QoS metrics and/or QoE metrics for the rendered viewport-specific XR visual media content from the target split rendering server are sufficiently good and/or better than the QoS metrics and/or QoE metrics for the rendered viewport-specific XR visual media content from the source split rendering server—and if so, to determine that the split rendering session should be relocated from the source split rendering server to the target split rendering server.

Upon determining that the split rendering session should be relocated from the source split rendering server to the target split rendering server, the element or function (e.g., DN 116, SMF 110, etc.) in the mobile communication network (e.g., network 100) can identify a particular point in time, frame, viewport, or the like, at which point the split rendering session is relocated from the source split rendering server to the target split rendering server.

In some embodiments, specific relocation information can be added to SplitRenderingConfiguration structure about the QOS metrics and/or QoE metric(s), configurational information about the source or target split rendering server, an identifier for the target split rendering server, and/or the like. Relocation parameters can be added to the existing data model (SplitRenderingConfiguration resource), such as provided in Table 7.2.2-2 in 3GPP TS 26.565, version 0.5.0. Table 2, below, illustrates properties for the data model for the SplitRenderingConfiguration resource, including additional properties of relocationStatus and relocationParameters, according to an example embodiment.

TABLE 2

| Property Name | Data Type | Cardinality | Description |
|---|---|---|---|
| Name | String | 1 . . . 1 | A name for this Split Rendering |
| | | | Configuration. |
| Status | Boolean | 1 . . . 1 | Indicates whether to this split |
| | | | rendering configuration is active. |
| edgeResourceConfigurationId | ResourceId | 0 . . . 1 | The identifier of the edge |
| | | | resource configuration that will |
| | | | be used for sessions of this split |
| | | | rendering configuration. |
| policyTemplateId | ResourceId | 1 . . . 1 | The identifier of the policy |
| | | | template that will be applied to |
| | | | the sessions of this split rendering |
| | | | configuration. |
| relocationStatus | Boolean | 1 . . . 1 | Indicates whether the split |
| | | | rendering is under relocation |
| | | | procedure. |
| relocationParameters | Object | 0 . . . 1 | Describes the relocation |
| | | | parameters if the relocationStatus |
| | | | flag is set to 1. It may include |
| | | | recommended timeline for |
| | | | relocation or reconfiguration |
| | | | elements. |
| Configuration | Object | 1 . . . 1 | Describes the split-rendering |
| | | | configuration currently used by |
| | | | the SRS. |

In some embodiments, timeline information, such as that provided in relocationStatus or relocationParameters, may be used, e.g., throughout the relocation procedure or relocation lifecycle, to manage new resource requests to split rendering servers, e.g., the current split rendering server. For example, if the system knows that the current split rendering session will be relocated in a particular number of seconds, such as 2 seconds, 3 seconds, 4 seconds, 5 seconds, or the like, it can anticipate the allocated resources at the current split rendering server will be freed up upon completion of the split rendering session relocation to the new split rendering server, and that those freed up resources at the current split rendering server can be used for other purposes.

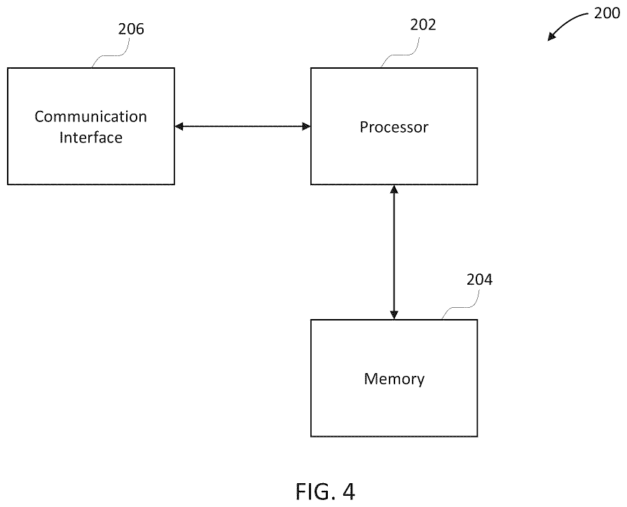

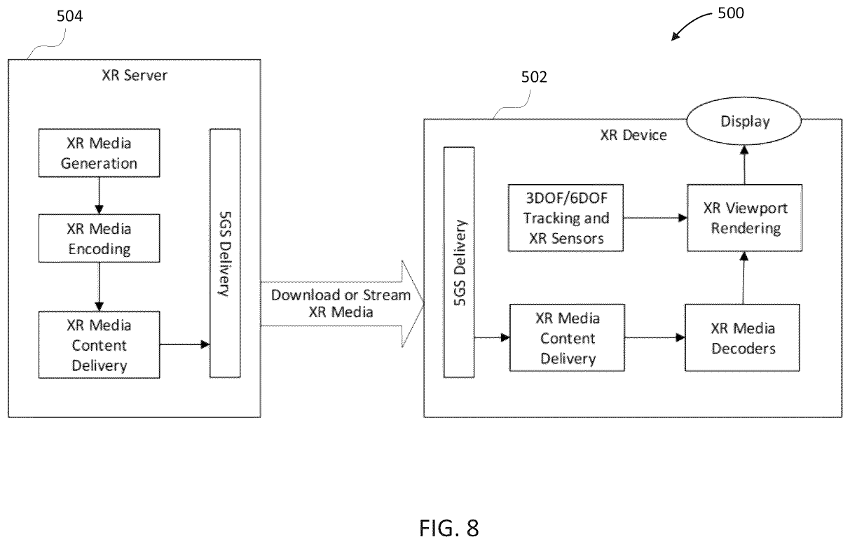

Turning now to FIG. 4, examples of a core network apparatus (CNA) (including the core network functions: UPF 106, AMF 108, SMF 110, PCF 114, and/or another NF and/or NRF) may be embodied in a core network apparatus 200 as configured in accordance with an example embodiment of the present disclosure. As described below in conjunction with the flowcharts of FIGS. 8-12, the CNA 200 of an example embodiment may be configured to perform the functions described herein. In any instance, the CNA 200 may more generally be a computing device or computing, such as a server, a standalone computer, a distributed computing system, or a cloud computing system. Regardless of the manner in which the CNA 200 is embodied, the apparatus of an example embodiment may be configured as shown in FIG. 4 so as to include, be associated with or otherwise be in communication with processing circuitry including, for example, a processor 202 and a memory device 204 and, in some embodiments, and/or a communication interface 206.

In the CNA 200, the processor 202 (and/or co-processors or any other circuitry assisting or otherwise associated with the processor 202) may be in communication with the memory device 204 via a bus for passing information among components of the CNA 200. The memory device 204 may include, for example, one or more volatile and/or non-volatile memories. In other words, for example, the memory device 204 may be an electronic storage device (e.g., a computer readable storage medium) comprising gates configured to store data (e.g., bits) that may be retrievable by a machine (e.g., a computing device like the processor 202). The memory device 204 may be configured to store information, data, content, applications, instructions, or the like for enabling the CNA 200 to carry out various operations of one or more core network functions in accordance with an example embodiment of the present disclosure. For example, the memory device 204 could be configured to buffer input data for processing by the processor 202. Additionally or alternatively, the memory device 204 could be configured to store instructions of core network functions for execution by the processor 202.

The processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally or alternatively, the processor 202 may include one or more other processors configured in tandem via the bus to enable independent execution of instructions, pipelining and/or multithreading.

In an example embodiment, the processor 202 may be configured to execute instructions stored in the memory device 204 or otherwise accessible to the processor 202. Alternatively or additionally, the processor 202 may be configured to execute hard coded functionality. As such, whether configured by hardware or software methods, or by a combination thereof, the processor 202 may represent an entity (e.g., physically embodied in circuitry) capable of performing operations according to an embodiment of the present disclosure while configured accordingly. Thus, for example, when the processor 202 is embodied as an ASIC, FPGA or the like, the processor 202 may be specifically configured hardware for conducting the operations described herein. Alternatively, as another example, when the processor 202 is embodied as an executor of instructions, the instructions may specifically configure the processor 202 to perform the algorithms and/or operations described herein when the instructions are executed. However, in some cases, the processor 202 may be a processor of a specific device (e.g., an encoder and/or a decoder) configured to employ an embodiment of the present invention by further configuration of the processor 202 by instructions for performing the algorithms and/or operations described herein. The processor 202 may include, among other things, a clock, an arithmetic logic unit (ALU) and logic gates configured to support operation of the processor 202.

In embodiments that include a communication interface 206, the communication interface 206 may be any means such as a device or circuitry embodied in either hardware or a combination of hardware and software that is configured to receive and/or transmit data from and/or to a network and/or any other device or module in communication with the CNA 200, such as an NF, an NRF (e.g., 124), a UE (e.g., 102), a RAN (e.g., 104) core network services, an application server and/or function (e.g., 112), a database or other storage device, etc. In this regard, the communication interface 206 may include, for example, an antenna (or multiple antennas) and supporting hardware and/or software for enabling communications with a wireless communication network. Additionally or alternatively, the communication interface 206 may include the circuitry for interacting with the antenna(s) to cause transmission of signals via the antenna(s) or to handle receipt of signals received via the antenna(s). In some environments, the communication interface 206 may alternatively or also support wired communication. As such, for example, the communication interface 206 may include a communication modem and/or other hardware and/or software for supporting communication via cable, digital subscriber line (DSL), universal serial bus (USB) or other mechanisms. In some embodiments, a session management function (e.g., 110) can comprise a 5GC session management function for any suitable CUPS architecture, such as for the gateway GPRS support node (GGSN-C), TWAG-C, BNG-CUPS, N4, Sxa, Sxb, Sxc, evolved packet core (EPC) SWG-C, EPC PGW-C, EPC TDF-C, and/or the like.

In some embodiments, the CNA 200 may represent a user equipment (e.g., 102) that is configured to be connected to other core network entities or network equipment. In some embodiments, user equipment can comprise a mobile telephone (cell phone) or the like.

As illustrated, the CNA 200 can include the processor 202 in communication with the memory 204 and configured to provide signals to and receive signals from the communication interface 206. In some embodiments, the communication interface 206 can include a transmitter and a receiver. In some embodiments, the processor 202 can be configured to control the functioning of the CNA 200, at least in part. In some embodiments, the processor 202 may be configured to control the functioning of the transmitter and receiver by effecting control signaling via electrical leads to the transmitter and receiver. Likewise, the processor 202 may be configured to control other elements of CNA 200 by effecting control signaling via electrical leads connecting the processor 202 to the other elements, such as a display or the memory 204. The processor 202 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 4 as a single processor, in some example embodiments the processor 202 may comprise a plurality of processors or processing cores.

The CNA 200 may be capable of operating with one or more air interface standards, communication protocols, modulation types, access types, and/or the like. Signals sent and received by the processor 202 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the CNA 200 and/or a cellular modem therein may be capable of operating in accordance with various first generation (1G) communication protocols, second generation (2G or 2.5G) communication protocols, third-generation (3G) communication protocols, fourth-generation (4G) communication protocols, fifth-generation (5G) communication protocols, Internet Protocol Multimedia Subsystem (IMS) communication protocols (for example, session initiation protocol (SIP) and/or the like. For example, the CNA 200 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the CNA 200 may be capable of operating in accordance with 2.5G wireless communication protocols General Packet Radio Service (GPRS), Enhanced Data GSM Environment (EDGE), and/or the like. Further, for example, the CNA 200 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The CNA 200 may be additionally capable of operating in accordance with 3.9G wireless communication protocols, such as Long Term Evolution (LTE), Evolved Universal Terrestrial Radio Access Network (E-UTRAN), and/or the like. Additionally, for example, the CNA 200 may be capable of operating in accordance with 4G wireless communication protocols, such as LTE Advanced, 5G, and/or the like as well as similar wireless communication protocols that may be subsequently developed. In some embodiments, the CNA 200 may be capable of operating according to or within the framework of any suitable control and user plane separation (CUPS) architecture, such as for the gateway GPRS support node (GGSN-C), trusted wireless access gateway (TWAG-C), broadband network gateways (BNGs), N4, Sxa, Sxb, Sxc, evolved packet core (EPC) SWG-C, EPC PGW-C, EPC TDF-C, and/or the like.

It is understood that the processor 202 may include circuitry for implementing audio and/or video and logic functions of the CNA 200. For example, the processor 202 may comprise a digital signal processor device, a microprocessor device, an analog-to-digital converter, a digital-to-analog converter, and/or the like. Control and signal processing functions of the CNA 200 may be allocated between these devices according to their respective capabilities. The processor 202 may additionally comprise an internal voice coder (VC), an internal data modem (DM), and/or the like. Further, the processor 202 may include functionality to operate one or more software programs, which may be stored in memory 204. In general, the processor 202 and software instructions stored in memory 206 may be configured to cause the CNA 200 to perform actions. For example, the processor 202 may be capable of operating a connectivity program, such as a web browser. The connectivity program may allow the CNA 200 to transmit and receive web content, such as location-based content, according to a protocol, such as wireless application protocol, WAP, hypertext transfer protocol, HTTP, and/or the like.

In some embodiments, the CNA 200 may also comprise a user interface including, for example, an earphone or speaker, a ringer, a microphone, a display, a user input interface, and/or the like, which may be operationally coupled to the processor 202. The display may, as noted above, include a touch sensitive display, where a user may touch and/or gesture to make selections, enter values, and/or the like. The processor 202 may also include user interface circuitry configured to control at least some functions of one or more elements of the user interface, such as the speaker, the ringer, the microphone, the display, and/or the like. The processor 202 and/or user interface circuitry comprising the processor 202 may be configured to control one or more functions of one or more elements of the user interface through computer program instructions, for example, software and/or firmware, stored on the memory 204 accessible to the processor 202, for example, a volatile memory, a non-volatile memory, devices comprising the same, and/or the like. The CNA 200 may include a battery for powering various circuits related to the mobile terminal, for example, a circuit to provide mechanical vibration as a detectable output. The user input interface may comprise devices allowing the CNA 200 to receive data, such as a keypad (e.g., a virtual keyboard presented on a display or an externally coupled keyboard) and/or the like.

As shown in FIG. 4, CNA 200 may also include one or more mechanisms for sharing and/or obtaining data, illustrated as the communication interface 206. For example, the communication interface 206 of the CNA 200 may include a short-range radio frequency (RF) transceiver and/or interrogator, so data may be shared with and/or obtained from electronic devices in accordance with RF techniques. The CNA 200 may include other short-range transceivers, such as an infrared (IR) transceiver, a Bluetooth™ (BT) transceiver operating using Bluetooth™ wireless technology, a wireless universal serial bus (USB) transceiver, a Bluetooth™ Low Energy transceiver, a ZigBee transceiver, an ANT transceiver, a cellular device-to-device transceiver, a wireless local area link transceiver, and/or any other short-range radio technology. In some embodiments, the CNA 200 and, in particular, the short-range transceiver may be capable of transmitting data to and/or receiving data from electronic devices within the proximity of the apparatus, such as within about 10 meters, for example. The CNA 200 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The CNA 200 may include volatile memory and/or non-volatile memory, which can comprise some or all of the memory 204 or can alternatively be a separate memory within or connected to the CNA 200. For example, volatile memory may include Random Access Memory (RAM) including dynamic and/or static RAM, on-chip or off-chip cache memory, and/or the like. Non-volatile memory, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory, non-volatile memory may include a cache area for temporary storage of data. At least part of the volatile and/or non-volatile memory may be embedded in processor 202. The memories may store one or more software programs, instructions, pieces of information, data, and/or the like. For example, the memory 204 may store software or instructions of one or more network functions of the core network which may be used by the apparatus for performing operations disclosed herein.

The memories may comprise an identifier, such as an international mobile equipment identification (IMEI) code, capable of uniquely identifying CNA 200. The memories may comprise an identifier, such as an international mobile equipment identification (IMEI) code, capable of uniquely identifying CNA 200. In the example embodiment, the processor 202 may be configured using computer code stored at memory and/or to the provide operations disclosed herein with respect to the base stations, WLAN access points, network nodes including the UEs, and the like. Likewise, the CNA 200 can be configured to be any other component or network equipment from the core network.

Some of the embodiments disclosed herein may be implemented in software, hardware, application logic, or a combination of software, hardware, and application logic. The software, application logic, and/or hardware may reside on the memory 204, the processor 202, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 4, computer-readable medium may comprise a non-transitory computer-readable storage medium that may be any media that can contain or store the instructions for use by or in connection with an instruction execution system, apparatus, or device, such as a computer.

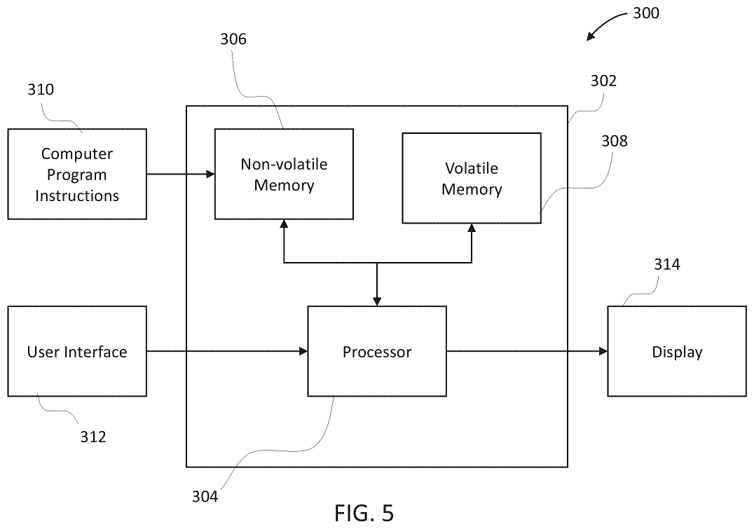

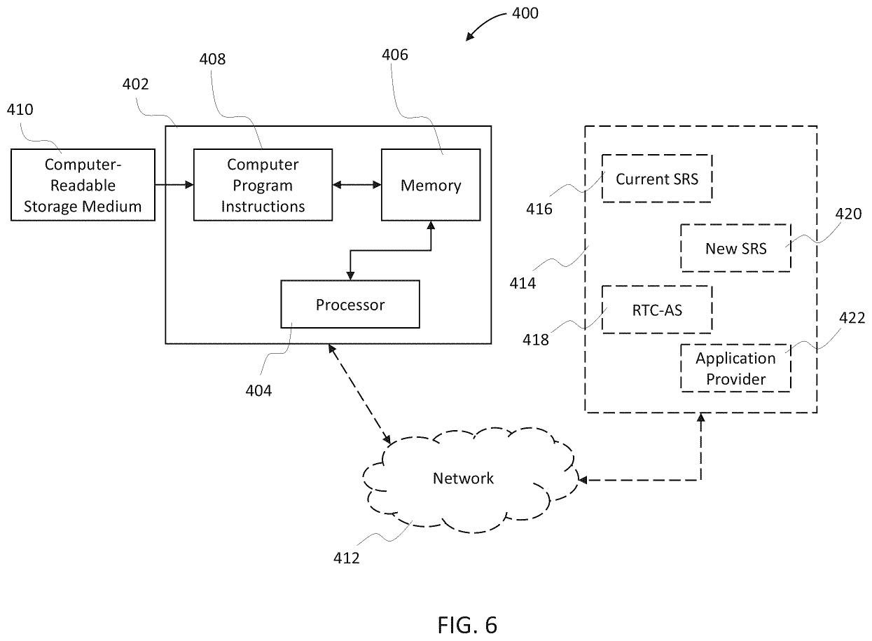

FIG. 5 illustrates an example of an apparatus, which may be configured in accordance with an example embodiment of the present disclosure. As described below in conjunction with FIGS. 6-12 and 15-24, the apparatus 300 may be a UE (e.g., UE 102) and may be configured to perform the functions, processes, and methods described herein, combinations thereof, variations thereof, or parts thereof. As described herein, the terms “UE”, “user device”, “terminal device”, “head-mounted display”, “XR device”, and “split rendering client” are often used interchangeably to refer to any apparatus, device, hardware, computing device, system, or sub-system configured to receive rendered XR media content from a provisioned split rendering server during a split rendering session, whether or not the receiving device is configured to display the XR media content, whether or not the receiving device is configured to measure, detect, calculate, sense, or otherwise determine a user's pose information, and whether or not the receiving device is rendering another portion of the XR media content in parallel with the provisioned split rendering server. Also, as described herein, the terms “server”, “edge server”, and “split rendering server” are often used interchangeably to refer to any function, element, node, engine, apparatus, device, server, component, system, or sub-system configured to render XR media content during a split rendering session.

In some embodiments, the apparatus 300 is or comprises exemplary specialized hardware particularly dimensioned and configured to carry out any of the methods, processes, and approaches described herein. In some embodiments, the apparatus 300 can be a part of the system 100 or in communication with a component thereof. It will be appreciated that the apparatus 300 is provided as an example of one embodiment and should not be construed to narrow the scope or spirit of the invention in any way. In this regard, the scope of the disclosure encompasses many potential embodiments in addition to those illustrated and described herein. As such, while FIG. 5 illustrates one example of a configuration of an apparatus for carrying our or facilitating various of the disclosed approaches and methods for seamless split rendering server provisioning and split rendering session relocation, other wireless communication system, such as a 5G system, a 6G system, or other configurations may also be used to implement certain embodiments of the present disclosure.

The apparatus 300 may be embodied as a desktop computer, laptop computer, mobile terminal, mobile computer, mobile phone, mobile communication device, game device, digital camera and/or camcorder, audio and/or video player, television device, radio receiver, digital video recorder, positioning device, a chipset, a computing device comprising a chipset, any combination thereof, and/or the like. In some example embodiments, the apparatus 300 is embodied as a mobile computing device, such as mobile telephones, mobile computers, personal digital assistants (PDAs), pagers, laptop computers, desktop computers, gaming devices, televisions, e-papers, and other types of electronic systems, which may employ various embodiments of the invention.

The apparatus 300 can include a computing device 302 including a processor 304, and storage, such as a non-volatile memory 306 and/or volatile memory 308. In some embodiments, the processor 304 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 5 as a single processor, in some embodiments the processor 304 comprises a plurality of processors. These signals sent and received by the processor 304 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, fifth-generation (5G), sixth-generation (6G), any band, frequency or protocol thereof, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

In addition to broad-band systems, some Narrow-band Advanced Mobile Phone System (NAMPS), as well as Total Access Communication System (TACS), mobile terminals may also benefit from embodiments of this invention, as should dual or higher mode phones (e.g., digital/analog or TDMA, CDMA, and/or analog phones). Additionally, the apparatus 300 or a component thereof may be capable of operating according to Wi-Fi or Worldwide Interoperability for Microwave Access (WiMAX) protocols.

It is understood that the processor 304 may comprise circuitry for implementing audio and/or video and logic functions of the apparatus 300. For example, the processor 304 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC), an internal data modem (DM), and/or the like. Further, the processor 304 may comprise functionality to operate one or more software programs, which may be stored in memory. For example, the processor 304 may be capable of operating a connectivity program, such as a web browser. The connectivity program may allow the apparatus 300 to transmit and receive web content, such as location-based content, according to a protocol, such as Wireless Application Protocol (WAP), hypertext transfer protocol (HTTP), and/or the like. The apparatus 300 may be capable of using a Transmission Control Protocol and/or Internet Protocol (TCP/IP) to transmit and receive web content across the internet or other networks.

The apparatus 300 may also comprise a user interface 312 including, for example, an earphone or speaker, a ringer, a microphone, a user display, a user input interface, and/or the like, which may be operationally coupled to the processor 304. In this regard, the processor 304 may comprise user interface circuitry configured to control at least some functions of one or more elements of the user interface, such as, for example, the speaker, the ringer, the microphone, the display, and/or the like. The processor 304 and/or user interface circuitry comprising the processor 304 may be configured to control one or more functions of one or more elements of the user interface through computer program instructions (e.g., software and/or firmware) stored on a memory accessible to the processor 304 (e.g., non-volatile memory 306, volatile memory 308, and/or the like). Although not shown, the apparatus 300 may comprise a battery for powering various circuits related to the apparatus 300, for example, a circuit to provide mechanical vibration as a detectable output. The apparatus 300 can further comprise a display 314. In some embodiments, the display 314 may be of any type appropriate for the electronic device in question with some examples including a plasma display panel (PDP), a liquid crystal display (LCD), a light-emitting diode (LED), an organic light-emitting diode display (OLED), a projector, a holographic display, or the like. The user interface 312 may comprise devices allowing the apparatus 300 to receive data, such as a keypad, a touch display (e.g., some example embodiments wherein the display 314 is configured as a touch display), a joystick (not shown), and/or other input device. In embodiments including a keypad, the keypad may comprise numeric (0-9) and related keys (#, *), and/or other keys for operating the apparatus 300.

The apparatus 300 may comprise memory, such as the non-volatile memory 306 and/or the volatile memory 308, such as RAM, read only memory (ROM), non-volatile RAM (NVRAM), a subscriber identity module (SIM), a removable user identity module (R-UIM), and/or the like. In addition to the memory, the apparatus 300 may comprise other removable and/or fixed memory. In some embodiments, the volatile memory 308 may include Random Access Memory (RAM) including dynamic and/or static RAM, on-chip or off-chip cache memory, and/or the like. In some embodiments, the non-volatile memory 306, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like the volatile memory 308, the non-volatile memory 306 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the apparatus 300.

In some example embodiments, the apparatus 300 includes various means for performing the various functions herein described. These means may comprise one or more of the processor 304, the non-volatile memory 306, the volatile memory 308, the user interface 312, or the display 314. The means of the apparatus 300 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g., storage 306 or 308) that is executable by a suitably configured processing device (e.g., the processor 304), or some combination thereof.

In some example embodiments, one or more of the means illustrated in FIG. 5 may be embodied as a chip or chip set. In other words, the apparatus 300 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 304, the memory 306 and/or 308, the user interface 312, and/or the display 314 may be embodied as a chip or chip set. The apparatus 300 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein.

The processor 304 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other types of hardware processors, or some combination thereof. Accordingly, although illustrated in FIG. 5 as a single processor, in some embodiments the processor 304 comprises a plurality of processors. The plurality of processors may be in operative communication with each other and may be collectively configured to perform one or more functionalities of the apparatus 300, e.g., as described herein. The plurality of processors may be embodied on a single computing device or distributed across a plurality of computing devices collectively configured to function as the apparatus 300. In some embodiments, e.g., wherein the apparatus is embodied as an apparatus 300, the processor 304 may be embodied as or comprise the processor 304 (shown in FIG. 5). In some example embodiments, the processor 304 is configured to execute instructions stored in the memory 306 and/or 308 or otherwise accessible to the processor 304. These instructions, when executed by the processor 304, may cause the apparatus 300 to perform one or more of the functionalities of the apparatus 300 as described herein. As such, whether configured by hardware or software methods, or by a combination thereof, the processor 304 may comprise an entity capable of performing operations according to embodiments of the present invention while configured accordingly. Thus, for example, when the processor 304 is embodied as an ASIC, FPGA or the like, the processor 304 may comprise specifically configured hardware for conducting one or more operations described herein. Alternatively, as another example, when the processor 304 is embodied as an executor of instructions, such as may be stored in the memory 306 and/or 308, the instructions may specifically configure the processor 304 to perform one or more algorithms and operations described herein.

The memory 306 and/or 308 may comprise, for example, volatile memory, non-volatile memory, or some combination thereof. In this regard, the memory 306 and/or 308 may comprise a non-transitory computer-readable storage medium. Although illustrated in FIG. 5 as a single memory, the memory 306 and/or 308 may comprise a plurality of memories. The plurality of memories may be embodied on a single computing device or may be distributed across a plurality of computing devices collectively configured to function as the apparatus 300. In various example embodiments, the memory 306 and/or 308 may comprise a hard disk, random access memory, cache memory, flash memory, a compact disc read only memory (CD-ROM), digital versatile disc read only memory (DVD-ROM), an optical disc, circuitry configured to store information, or some combination thereof. In some embodiments, the memory 306 and/or 308 may comprise the volatile memory 308 and/or the non-volatile memory 306 (shown in FIG. 5). The memory 306 and/or 308 may be configured to store information, data, applications, instructions, or the like for enabling the apparatus 300 to carry out various functions in accordance with various example embodiments. For example, in some example embodiments, the memory 306 and/or 308 is configured to buffer input data for processing by the processor 304. Additionally or alternatively, the memory 306 and/or 308 may be configured to store program instructions for execution by the processor 304. The memory 306 and/or 308 may store information in the form of static and/or dynamic information. The stored information may include, for example, images, content, media content, user data, application data, and/or the like. This stored information may be stored and/or used by the processor 304 during the course of performing its functionalities.

In some embodiments, the apparatus 300 can further comprise a communication interface (not shown) that may be embodied as any device or means embodied in circuitry, hardware, a computer program product comprising computer readable program instructions stored on a computer readable medium (e.g., the memory 306 and/or 308) and executed by a processing device (e.g., the processor 304), or a combination thereof that is configured to receive and/or transmit data from and/or to another computing device. In some example embodiments, the communication interface is at least partially embodied as or otherwise controlled by the processor 304. In this regard, the communication interface may be in communication with the processor 304, such as via a bus. The communication interface may include, for example, an antenna, a transmitter, a receiver, a transceiver and/or supporting hardware or software for enabling communications with one or more remote computing devices. In some embodiments, e.g., wherein the apparatus is embodied as an apparatus 300, the communication interface may be embodied as or comprise the transmitter and the receiver. The communication interface may be configured to receive and/or transmit data using any protocol that may be used for communications between computing devices. In this regard, the communication interface may be configured to receive and/or transmit data using any protocol that may be used for transmission of data over a wireless network, wireline network, some combination thereof, or the like by which the apparatus 300 and one or more computing devices may be in communication. As an example, the communication interface may be configured to receive and/or otherwise access content (e.g., web page content, streaming media content, and/or the like) over a network from a server or other content source. The communication interface may additionally be in communication with the memory 306 and/or 308, user interface 312 and/or the processor 304, such as via a bus.

The user interface 312 may be in communication with the processor 304 and configured to receive an indication of a user input and/or to provide an audible, visual, mechanical, or other output to a user. As such, the user interface 312 may include, for example, a keyboard, a mouse, a joystick, a display, a touch screen display, a microphone, a speaker, and/or other input and/or output mechanisms. In embodiments in which the apparatus 300 is embodied as an apparatus 300, the user interface 312 may be embodied as or comprise the user input interface, such as the display 314 (shown in FIG. 5), and other components such as a keypad, mouse, etc. The user interface 312 may be in communication with the memory 306 and/or 308, communication interface, a sensor, a speaker, and/or the processor 304, such as via a bus. In some example embodiments, the user interface 312 may comprise a single input and/or output mechanism. In other embodiments, the user interface 312 may comprise a content display and touch display, such as the display 314. In some embodiments, the user interface 312 may comprise a touch display user interface with a content display portion and a dedicated user input portion, such as a virtual keyboard, virtual piano, or an application with a designated key for user input.

The processor 304 may be embodied as various means, such as circuitry, hardware, a computer program product comprising computer readable program instructions stored on a computer readable medium (e.g., the memory 306 and/or 308) and executed by a processing device (e.g., the processor 304), or some combination thereof and, in some embodiments, is embodied as or otherwise controlled by the processor 304. The processor 304 may further be in communication with one or more of the memory 306 and/or 308, or user interface 312, such as via a bus.

The processor 304 may be configured to receive a user input from a user interface 312, such as a touch display. The user input or signal may carry positional information indicative of the user input. In this regard, the position may comprise a position of the user input in a two-dimensional space, which may be relative to the surface of the touch display user interface. For example, the position may comprise a coordinate position relative to a two-dimensional coordinate system (e.g., an X and Y axis), such that the position may be determined. Accordingly, the processor 304 may determine an element, instruction, and/or command that corresponds with a key, or image, displayed on the touch display user interface at the determined position or within a predefined proximity (e.g., within a predefined tolerance range) of the determined position. The processor 304 may be further configured to perform a function or action related to the key corresponding to the element, instruction, and/or command determined by the processor 304 based on the position of the touch or other user input.

Without in any way limiting the scope, interpretation, or application of the claims appearing below, a technical effect of one or more of the example embodiments disclosed herein may be improved user equipment or network equipment configuration. As such, any embodiment of a method, system, approach, device, apparatus, or computer program described or illustrated herein is understood to comprise any or all of the components, functionalities, elements, or steps of any other embodiment such that any method can be carried out by the CNA 200, the apparatus 300, or by any other suitable system or device, and likewise can be carried out according to a computer program code envisioned within the scope of this disclosure.

In some embodiments, edge server provisioning and split rendering session relocation can be facilitated, controlled, managed, or otherwise coordinated by a Real-Time Communication Application Function (RTC-AF), such as an RTC-AF in a fifth-generation core network (5GCN) or the like. An RTC-AF can be a hardware-based network function, a logical network function, a software-defined network function, a fully virtualized network function, or provided in any other suitable manner. An RTC-AF can be configured to communicate with a PCF (e.g., 114), an SMF (e.g., 110), a Network Exposure Function (NEF), a UDM (e.g., 118) a UPF (e.g., 106a, 106b), a gNodeB (e.g., 104), an AMF (e.g., 108), an AUSF (e.g., 120), a Security Edge Protection Proxy (SEPP), a UE (e.g., 102), an Application Provider, a Real-Time Communication Application Server (RTC-AS), one or more split rendering servers (SRS), a SWAP server, any other function, element, node, server, or component of a core network (e.g., 101) or a data network (e.g., 116), and/or the like.

FIG. 6 illustrates an example of an apparatus 400 that comprises, and/or is configured to operate or function as, an RTC-AF 402. In some embodiments, the RTC-AF 402 can comprise a processor 404 and a memory 406. The memory 406 can store therein or be in communication with computer program code or instructions 408 that, when executed by the processor 404, cause the apparatus 400 (e.g. RTC-AF 402) to perform actions or methods, such as those described herein, that facilitate seamless relocation of split rendering sessions between different split rendering servers to improve XR media content quality, alleviate server congestion, efficiently use split rendering resources across the communication network, and/or the like. The apparatus 400 can include similar elements, features, components, and functionalities as other such computing devices described herein (e.g., 102, 106, 108, 110, 112, 114, 116, 118, 120, 122, 124, 200, 300). Alternatively, the apparatus 400 can include different or additional features or components, and be configured to carry out different or additional operations as compared to these other computing devices.

The apparatus 400 can include or be in communication with a computer-readable storage medium 410, which can be similar to or the same as that described elsewhere in this disclosure. The computer-readable storage medium 410 can be embodied as and/or stored on any suitable computer program product, such as a transitory or non-transitory storage medium. The computer-readable storage medium 410 can be configured to communicate some or all of the computer program code or instructions 408 to the memory 406 of the RTC-AF 402, whether initially, iteratively, continuously, sporadically, on demand, as needed, or otherwise.

The apparatus 400 or RTC-AF 402 can be configured to communication with a network 412, such as the Internet, a communication network, an internet-of-things (IoT) network, and/or the like. The network 412 can be a core network (e.g., CN 101) or data network (e.g., DN 116). The network 412 can comprise or be in operable communication with a split rendering services network 414 that includes various components, subsystems, hardware, functions, nodes, or network elements configured to facilitate rendering for a split rendering session with a UE (e.g., UE 102). The split rendering services network 414 can include, for example, a current split rendering server 416 (current SRS 416), an Real-Time Communication Application Server 418 (RTC-AS 418), a new SRS 420, and/or an Application Provider 422. The split rendering services network 414 can also be in communication with the network 412. Alternatively, the split rendering services network 414 can comprise or be comprised within the network 412. The specific network architecture or sub-system configuration used may not materially affect the operations of the RTC-AF 402. Instead, the RTC-AF 402 can be configured to be operably coupled to, in communication with, and/or part of the split rendering services network 414, according to some embodiments.

Alternatively, one or more of the current SRS 416, new SRS 420, RTC-AS 418, and/or Application Provider 422 can be located in one or more other sub-systems or sub-networks of the communication network (e.g., 5GS, 5GCN, DN, etc.). Nevertheless, the RTC-AF 402 can be configured to receive, measure, calculate, or otherwise determine metrics, such as QoS metrics, QoE metrics, KPIs of the current and/or new SRS 416, 420, and/or the like, associated with a split rendering session, and determine whether and when to relocate the split rendering session from the current SRS 416 to the new SRS 420. The RTC-AF 402 could, for example, determine based on one or more QoE metrics, that there has been a degradation in a render quality of the viewport observed by the user when consuming the XR media content as rendered by the current SRS 416. Additionally or alternatively, the RTC-AF 402 could, for example, determine based on one or more QOS metrics, that there has been a degradation in a data quality, network usability, packet transmissibility, packet reception, packet interpretation, network traffic management, server resource availability, packet traffic congestion, or other QoS metrics, and/or the like. Additionally or alternatively, the RTC-AF 402 could, for example, determine based on one or more key performance indicators (KPIs) associated with the current SRS 416 that there has been a degradation in the operability, operating efficiency, operating efficacy, resource availability, or other KPIs, and/or the like. Based on such a degradation being observed by the RTC-AF 402, the RTC-AF 402 can determine that the split rendering session needs to be relocated to another server or edge resource. The RTC-AF 402 can pick the new SRS 420, e.g., from among a plurality of SRSs. The RTC-AF 402 can also communicate the need for split rendering session relocation to the new SRS 420, the RTC-AS 418, and/or the Application Provider 422.

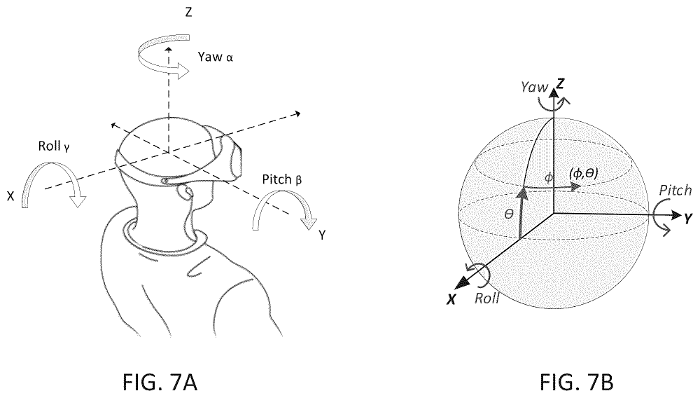

FIG. 7A illustrates an example of a split rendering client device (e.g., UE 102) configured to be worn by a user and inclusive of a display for displaying viewport-specific XR media content received from a split rendering server and one or more sensors configured to gather pose and locational information about the split rendering client device, which is indicative of user movements that must be accounted for when adjusting the viewport and field of view of subsequent XR media content to be rendered by the split rendering server and sent to the split rendering client device. As illustrated, at least 3DOF are monitored either referentially or absolutely to determine pitch, roll, and yaw, as well as attitude, translational motion of the user based upon translational motion of the client device, elevation, attitude, and/or other characteristics. Aspects or characteristics aside from static pose and positional information, such as dynamic movement, motion, posture, gait, direction of travel, rotational motion, pace of movements, and other information about user location, direction, head motion, pose, body movements, gait, or other characteristics can additionally or alternatively be measured, monitored, calculated, estimated, or otherwise determined. The various axes of pose, location, movement, viewing direction and angle, and other characteristics can be considered as part of a ‘reference system’ that mimics the user's visual and auditory field of view as if the user were actually located at the center point (e.g., viewpoint) within the immersive virtualized landscape and environment being rendered by the split rendering server(s) for the client device (e.g., UE 102).

While the real-world movements of the user and corresponding real-world movement, pose, position, angle, attitude, pitch, roll, and yaw of the client device in FIG. 7A can be referred to as illustrative of a ‘reference system’, the corresponding virtualized landscape can be thought of as a spherical virtual landscape or environment with a center point within the sphere, which can be considered as part of a ‘coordinate system’ for purposes of rendering the virtual landscape relative to the corresponding reference system based user pose, position, and viewing direction information, among other information.

FIG. 7B illustrates an example ‘coordinate system’ specified for defining the sphere coordinates azimuth (ϕ) and elevation (θ) for identifying a location of a point on the unit sphere, as well as the rotation angles yaw (αα), pitch (ββ), and roll (γγ). The origin of the coordinate system is usually the same as the center point of a device or rig used for audio or video acquisition as well as the position of the user's head in the 3D space in which the audio or video are rendered. The X axis corresponds to the back-to-front axis illustrated in FIG. 7A, Y axis corresponds to the side-to-side (or lateral) axis illustrated in FIG. 7A, and the Z axis corresponds to the vertical (or up) axis illustrated in FIG. 7A. Additional information about the ‘reference system’ and ‘coordinate system’ is provided in 3GPP TS 26.118, version 18.0.0, the entire disclosure of which is hereby incorporated herein by reference in its entirety for all purposes.

In the context of mobile communication networks, e.g., the network 100, and understanding the real-world ‘reference system’ of a split rendering client device, e.g., the UE 102, that corresponds to the virtualized ‘coordinate system’ of the XR visual media content being rendered by split rendering server(s), several of the various options for XR end-to-end rendering architecture are briefly described below with reference to FIGS. 8-14.

FIG. 8 illustrates an example system architecture 500 for viewport-independent XR media delivery of XR media content from a split rendering server (i.e., XR Server 504) to a split rendering client (i.e., XR Device 502) in which the pose, locational, and positional information are retained at the XR Device 502, the XR Server 504 provides only raw XR media content, and XR viewport rendering is carried out entirely by the XR Device 502. As described above, the computational complexity, bandwidth requirements, incurred latency, financial cost, and bulkiness and/or unwieldiness of the XR Device 502 makes such an approach undesirable. In some embodiments, the XR Device 502 can be the same as, or similar to, the UE 102 and/or the apparatus 300, whether in terms of structure, subcomponents, arrangement, functionality, and/or the like. In some embodiments, the XR Device 502 can be a part of the UE 102 and/or the apparatus 300; or, conversely, the UE 102 and/or the apparatus 300 can be a part of the XR Device 502. In some embodiments, the XR Server 504 can be the same as, or similar to, the CNA 200 and/or the apparatus 400, whether in terms of structure, subcomponents, arrangement, functionality, and/or the like. In some embodiments, the XR Device 502 can be a part of the CNA 200 and/or the apparatus 400; or, conversely, the CNA 200 and/or the apparatus 400 can be a part of the XR Device 502.

The XR Device 502 and/or the XR Server 504 illustrated in FIG. 8 can use, be in communication with, or be a part of a communication network, such as a 5GS [fifth-generation system], 6GS [sixth-generation system], a core network (e.g., 5GCN), and/or the like. As illustrated, the XR Server 504 may be configured to communicate the XR media content to the XR Device 502 using or via a communication network (e.g. a 5GS), such as 100. For example, the XR Server 504 may include 5GS delivery module for communicating XR media content via a communication network (e.g., 5GS) to a 5GS delivery module of the XR Device 502. Further, the XR Device 502 can be configured to receive the XR media content from the XR Server 504 using or via a communication network, such a 5GS, such as 100. For example, a 5GS deliver module of the XR Device 502 may be configured to communicate XR media content. In some embodiments, the XR Server 504 can be a element of a network (e.g., network 100) or network function of the 5GS (e.g., 100). In some other embodiments, the XR Server 504 can be a part of an edge network or data network in communication with the 5GS (e.g., 100) such that the 5GS can facilitate the transmission of XR media content to the XR Device 502 and so that components of the 5GS (e.g., RTC-AF 402) can monitor metrics and qualities of the XR media content, functionality of the XR Server 504, playback of the rendered XR media content at the XR Device 502, and/or other characteristics or indicators during a split rendering session. Based on this monitoring, the XR Server 504 or an element or function in the 5GS (e.g., RTC-AF 402) can be configured to initiate, facilitate, or carry out a relocation of the split rendering session from the XR Server 504 to another XR Server (not shown). Embodiments of this relocation procedure are described in more detail elsewhere in this disclosure.

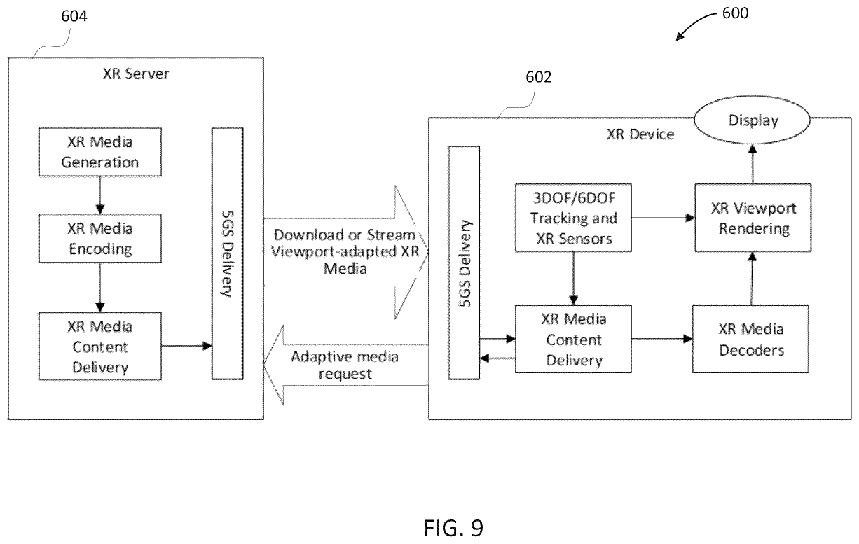

FIG. 9 illustrates an example system architecture 600 for viewport dependent delivery of XR media from a XR Server 604 to an XR Device 602 for rendering a viewport for display to a user. In this example system architecture 600, pose information and the like are only provided from the XR Device 602 to the XR Server 604 in an adaptive media request. In some embodiments, an adaptive media request is provided to the XR Server 604 by the XR Device 602 to specifically request that the XR Server 604 only send XR media content that is relevant for the current viewport of the user. Upon receipt of the adaptive media request, and based on the pose information provided by the XR Device 602, the XR Server 604 determines the current viewport of the user and determines from that viewport a portion of the total XR media content and/or virtual landscape to include in the render to the XR Device 602 such that the rendered XR media content provided to the XR Device 602 is viewport-specific. In system architecture 600 extensive and computationally expensive rendering of the XR media content is performed at the XR Device 602 for nearly all rendering activities, which is undesirable. In some embodiments, the XR Device 602 can be the same as, or similar to, the UE 102, the apparatus 300, and/or the XR Device 602, whether in terms of structure, subcomponents, arrangement, functionality, and/or the like. In some embodiments, the XR Device 602 can be a part of the UE 102, the apparatus 300, and/or the XR Device 602; or, conversely, the UE 102, the apparatus 300, and/or the XR Device 502 can be a part of the XR Device 602. In some embodiments, the XR Server 604 can be the same as, or similar to, the CNA 200, the apparatus 400, and/or the XR Server 604, whether in terms of structure, subcomponents, arrangement, functionality, and/or the like. In some embodiments, the XR Device 602 can be a part of the CNA 200, the apparatus 400, and/or the XR Server 504; or, conversely, the CNA 200, the apparatus 400, and/or the XR Server 604 can be a part of the XR Device 602.

The XR Server 504 and the XR Device 6023 illustrated in FIG. 9 can use, be in communication with, or be a part of a communication network, such as a 5GS [fifth-generation system], 6GS [sixth-generation system], a core network (e.g., 5GCN), and/or the like. As illustrated, the XR Server 604 may be configured to communicate the XR media content to the XR Device 602 using or via 5GS. For example, the XR Server 604 may include a 5GS Delivery module configured to communicate XR media content to a 5GS Delivery module of the XR Device 602 via a 5GS. Further, the XR Device 602 can be configured to receive the XR media content from the XR Server 604 via 5GS or the like. For example, the XR Device 602 may include a 5GS Delivery module configured to receive XR media content to a 5GS Delivery module of the XR Server 604 via a 5GS. In some embodiments, the XR Server 604 can be a element of a network or network function of the 5GS (e.g., network 100). In some other embodiments, the XR Server 604 can be a part of an edge network or data network in communication with the 5GS (e.g., network 100) such that the 5GS can facilitate the transmission of XR media content to the XR Device 602 and so that components of the 5GS (e.g., RTC-AF 402) can monitor metrics and qualities of the XR media content, functionality of the XR Server 604, playback of the rendered XR media content at the XR Device 602, and/or other characteristics or indicators during a split rendering session. Based on this monitoring, the XR Server 604 or an element or function in the 5GS (e.g., RTC-AF 402) can be configured to initiate, facilitate, or carry out a relocation of the split rendering session from the XR Server 604 to another XR Server (not shown). Embodiments of this relocation procedure are described in more detail elsewhere in this disclosure.

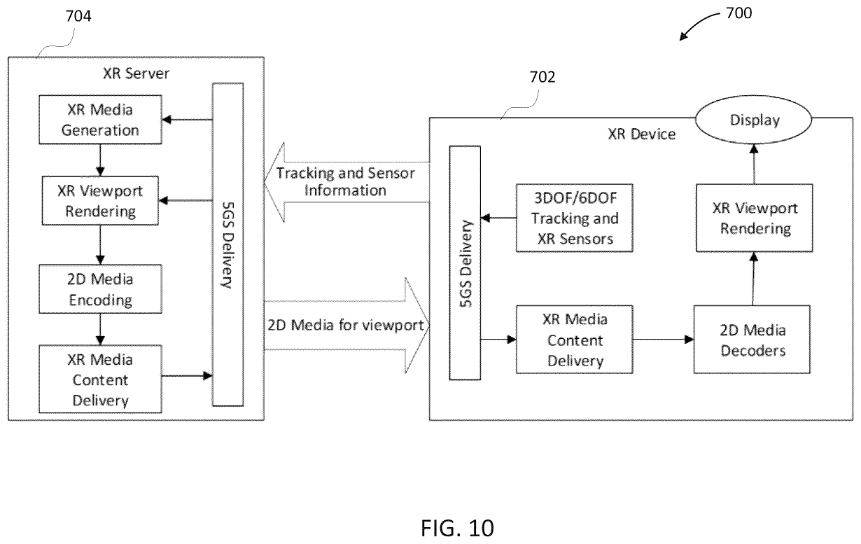

FIG. 10 illustrates a viewport rendering in network approach 700 for an XR Server 704 to receive pose information (i.e., Tracking and Sensor Information) from an XR Device 702, and to deliver two-dimensional (2D) media for a corresponding viewport that is determined based on the Tacking and Sensor Information. However, the rendering of the viewport is carried out at the XR Device 702 for display to a user. In this example approach, the flattened (2D) format media content is also encoded at the XR Server 704 and therefore must be decoded and then rendered from 2D into the 3D XR Viewport Rendering that can be displayed to the user. This approach also relies on extensive and computationally expensive rendering at the XR Device 702 for nearly all rendering activities, which is undesirable. In some embodiments, the XR Device 702 can be the same as, or similar to, the UE 102, the apparatus 300, the XR Device 502, and/or the XR Device 602, whether in terms of structure, subcomponents, arrangement, functionality, and/or the like. In some embodiments, the XR Device 702 can be a part of the UE 102, the apparatus 300, the XR Device 502, and/or the XR Device 602; or, conversely, the UE 102, the apparatus 300, the XR Device 502, and/or the XR Device 602 can be a part of the XR Device 702. In some embodiments, the XR Server 704 can be the same as, or similar to, the CNA 200, the apparatus 400, the XR Server 504, and/or the XR Server 604, whether in terms of structure, subcomponents, arrangement, functionality, and/or the like. In some embodiments, the XR Device 702 can be a part of the CNA 200, the apparatus 400, the XR Server 504, and/or the XR Server 604; or, conversely, the CNA 200, the apparatus 400, the XR Server 504, and/or the XR Server 604 can be a part of the XR Device 702.

FIG. 10 illustrates an example system architecture for viewport rendering in a network that includes an XR Device 702 and an XR Server 702. The XR Device 702 and/or the XR Device 704 can use, or be in communication with, or be a part of a communication network, such as a 5GS [fifth-generation system], 6GS [sixth-generation system], a core network (e.g., 5GCN), and/or the like. As illustrated, the XR Server 704 may be configured to communicate the XR media content to the XR Device 702 using or via 5GS or the like. For example, XR Server 704 may include a 5GS Delivery module configured to communicate the XR media content to a 5GS Delivery module of the XR Device 702 using or via 5GS or the like. Further, the XR Device 702 can be configured to receive the XR media content from the XR Server 704 via a 5GS or the like. For example, the XR Device 702 may include a 5GS Delivery module configured to receive the XR media content from a 5GS Delivery module of the XR Server 704 via a 5GS or the like. In some embodiments, the XR Server 704 can be a element of a network or network function of the 5GS (e.g., 100). In some other embodiments, the XR Server 704 can be a part of an edge network or data network in communication with the 5GS (e.g., 100) such that the 5GS can facilitate the transmission of XR media content to the XR Device 702 and so that components of the 5GS (e.g., RTC-AF 402) can monitor metrics and qualities of the XR media content, functionality of the XR Server 704, playback of the rendered XR media content at the XR Device 702, and/or other characteristics or indicators during a split rendering session. Based on this monitoring, the XR Server 704 or an element or function in the 5GS (e.g., RTC-AF 402) can be configured to initiate, facilitate, or carry out a relocation of the split rendering session from the XR Server 704 to another XR Server (not shown). Embodiments of this relocation procedure are described in more detail elsewhere in this disclosure.

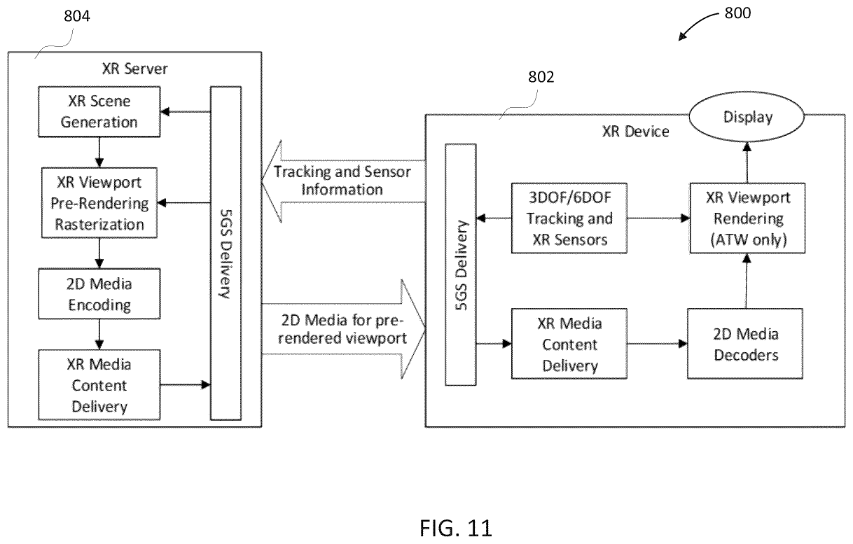

FIG. 11 illustrates a raster-based split rendering approach 800 for an XR server 804 to generate an XR Scene based on Tracking and Sensor Information provided by an XR Device 802. In the approach 800, the XR Server 804 runs an XR engine to generate the XR Scene based on the Tracking and Sensor Information provided by the XR device 802, and then the XR engine rasterizes the XR Scene into 2D media and encodes the 2D media before delivering the encoded 2D media to the XR Device 802 via a communication network using a 5GS delivery module. The XR Device 802, upon receipt of the encoded 2D media from the XR Server 804, decodes the encoded 2D media to generate the XR Viewport before it can display the XR viewport-specific media to a user. While the end-to-end latency, absent any other traffic being communicated by the communication network, and based on relatively noncomplex XR media content and pose information, be less than about 100 ms, or even less than about 75 ms, according to this approach 800. However, with the continued miniaturization of XR user devices and continued use of over-the-air (e.g., 5G Internet of Things [5G IoT]) rendered viewport transmission, and with the continued increase in the magnitude of viewport renders being desired for affecting increasingly immersive and seamless user experiences, this latency range will increase and the power and computing requirements for such rendering from a rasterized XR Scene by the XR Device 802 is already unsustainable and will continue to become more untenable. As such, as with the approaches (e.g., 500, 600, 700) described above, this approach 800 also relies on extensive and overly computationally expensive rendering at the XR Device 802 for nearly all rendering activities, which is undesirable. In some embodiments, the XR Device 802 can be the same as, or similar to, the UE 102, the apparatus 300, the XR Device 502, the XR Device 602, and/or the XR Device 702, whether in terms of structure, subcomponents, arrangement, functionality, and/or the like. In some embodiments, the XR Device 802 can be a part of the UE 102, the apparatus 300, the XR Device 502, the XR Device 602, and/or the XR Device 702; or, conversely, the UE 102, the apparatus 300, the XR Device 502, the XR Device 602, and/or the XR Device 702 can be a part of the XR Device 802. In some embodiments, the XR Server 804 can be the same as, or similar to, the CNA 200, the apparatus 400, the XR Server 504, the XR Server 604, and/or the XR Server 704, whether in terms of structure, subcomponents, arrangement, functionality, and/or the like. In some embodiments, the XR Device 802 can be a part of the CNA 200, the apparatus 400, the XR Server 504, the XR Server 604, and/or the XR Server 704; or, conversely, the CNA 200, the apparatus 400, the XR Server 504, the XR Server 604, and/or the XR Server 704 can be a part of the XR Device 802.

The viewport-independent XR media delivery approach 800 illustrated in FIG. 11 can use, be in communication with, or be a part of a communication network, such as a 5GS [fifth-generation system], 6GS [sixth-generation system], a core network (e.g., 5GCN), and/or the like. As illustrated, the XR Server 804 may be configured to communicate the XR media content to the XR Device 802 using or with 5GS or the like, such as 100. Further, the XR Device 802 can be configured to receive the XR media content from the XR Server 804 via such a 5GS or the like, such as 100. In some embodiments, the XR Server 804 can be a element of a network (e.g., network 100) or network function of the 5GS (e.g., network 100). In some other embodiments, the XR Server 804 can be a part of an edge network or data network in communication with the 5GS (e.g., 100) such that the 5GS can facilitate the transmission of XR media content to the XR Device 802 and so that components of the 5GS (e.g., RTC-AF 402) can monitor metrics and qualities of the XR media content, functionality of the XR Server 804, playback of the rendered XR media content at the XR Device 802, and/or other characteristics or indicators during a split rendering session. Based on this monitoring, the XR Server 804 or a element of a network (e.g., network 100) or network function of the 5GS (e.g., RTC-AF 402) can be configured to initiate, facilitate, or carry out a relocation of the split rendering session from the XR Server 804 to another XR Server (not shown). Embodiments of a relocation procedure for relocating the split rendering session from the XR Server 804 to another XR Server (not shown) are described in more detail elsewhere in this disclosure.

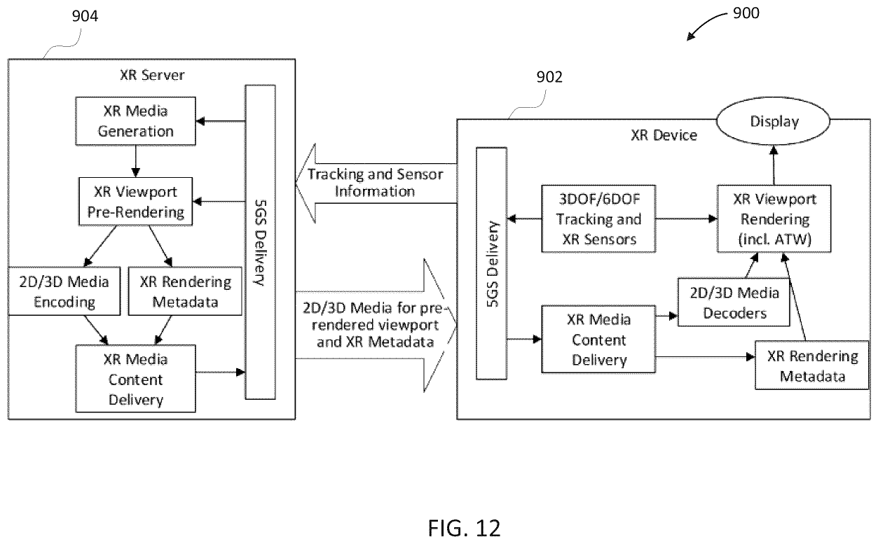

FIG. 12 illustrates an example XR split rendering approach 900 for delivering 2D and/or 3D XR media content from a XR Server 904 to an XR Device 902 for viewport rendering. In this example approach, pose information and the like are provided from the XR Device 902 to the XR Server 904 as Tracking and Sensor Information, and the XR Device 902 generates the XR media, carries out pre-rendering of the XR Viewport, generates a partially 2D/partially 3D version of the XR Media, encodes the XR media and generates rendering metadata to aid the XR Device 902 in re-rendering the 2D and/or 3D Media to form the re-rendered XR Viewport based on the accompanying rendering metadata. In many cases, such as when the buffer from the split rendering at the XR Server 904 is based on Tracking and Sensor Information associated with minimal or relatively minimal user viewpoint and/or viewport changes across a particular frame range, the XR Server 904 may determine that a 2D frame buffer will suffice since the XR Device 902 is also receiving rendering metadata to assist the XR Device 902 in re-rendering the XR viewport for display to the user. However, as noted above, with the continued miniaturization of XR user devices and continued use of over-the-air (e.g., 5G Internet of Things [5G IoT]) rendered viewport transmission, and with the continued increase in the magnitude of viewport renders being desired for affecting increasingly immersive and seamless user experiences, such re-rendering scenarios may not always be suitable, nor will a single XR Server 904 be continuously reliable and suitable for providing split rendering services to a split rendering client (e.g., XR Device 902) due to changing network traffic circumstances and technical issues at an XR Server 904. As such, as with the approaches (e.g., 500, 600, 700, 800) described above, this approach 900 also relies on extensive and overly computationally expensive re-rendering at the XR Device 902 for nearly all rendering activities. However, even if the approach 900 is suitable for XR Servers 904 to provide split rendering services to XR Devices 902 during a particular period of time, the approach 900 does not provide any manner for seamless relocation of split rendering services from the XR Server 904 to another XR Server (not shown) in the inevitable circumstance in which QoS and/or QoE of the XR Viewport re-rendered at the XR Device 902 degrades due to degraded 2D and/or 3D media quality or degrading XR Rendering Metadata quality at the XR Server 904. In some embodiments, the XR Device 902 can be the same as, or similar to, the UE 102, the apparatus 300, the XR Device 502, the XR Device 602, the XR Device 702, and/or the XR Device 802, whether in terms of structure, subcomponents, arrangement, functionality, and/or the like. In some embodiments, the XR Device 902 can be a part of the UE 102, the apparatus 300, the XR Device 502, the XR Device 602, the XR Device 702, and/or the XR Device 802; or, conversely, the UE 102, the apparatus 300, the XR Device 502, the XR Device 602, the XR Device 702, and/or the XR Device 802 can be a part of the XR Device 902. In some embodiments, the XR Server 904 can be the same as, or similar to, the CNA 200, the apparatus 400, the XR Server 504, the XR Server 604, the XR Server 704, and/or the XR Server 804, whether in terms of structure, subcomponents, arrangement, functionality, and/or the like. In some embodiments, the XR Device 902 can be a part of the CNA 200, the apparatus 400, the XR Server 504, the XR Server 604, the XR Server 704, and/or the XR Server 804; or, conversely, the CNA 200, the apparatus 400, the XR Server 504, the XR Server 604, the XR Server 704, and/or the XR Server 804 can be a part of the XR Device 902.

The viewport-independent XR media delivery approach 900 illustrated in FIG. 12 can use, be in communication with, or be a part of a communication network, such as a 5GS [fifth-generation system], 6GS [sixth-generation system], a core network (e.g., 5GCN), and/or the like. As illustrated, the XR Server 904 may be configured to communicate the XR media content to the XR Device 902 using or with 5GS or the like, such as 100. Further, the XR Device 902 can be configured to receive the XR media content from the XR Server 904 via such a 5GS or the like, such as 100. In some embodiments, the XR Server 904 can be a element of a network (e.g., network 100) or network function of the 5GS (e.g., 100). In some other embodiments, the XR Server 904 can be a part of an edge network or data network in communication with the 5GS (e.g., 100) such that the 5GS can facilitate the transmission of XR media content to the XR Device 902 and so that components of the 5GS (e.g., RTC-AF 402) can monitor metrics and qualities of the XR media content, functionality of the XR Server 904, playback of the rendered XR media content at the XR Device 902, and/or other characteristics or indicators during a split rendering session. Based on this monitoring, the XR Server 904 or an element or function in the 5GS (e.g., RTC-AF 402) can be configured to initiate, facilitate, or carry out a relocation of the split rendering session from the XR Server 904 to another XR Server (not shown). Embodiments of this relocation procedure are described in more detail elsewhere in this disclosure.

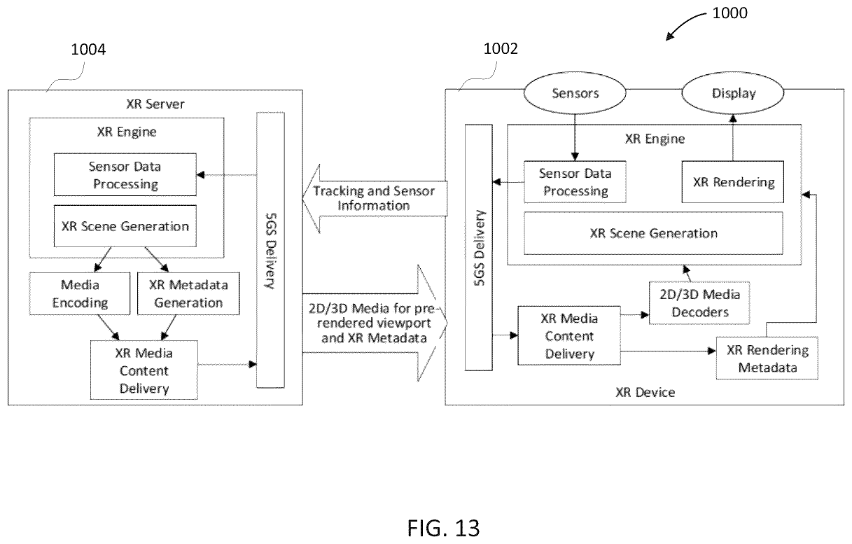

FIG. 13 illustrates a distributed computing XR media delivery approach 1000 in which an XR Device 1002 sends Tracking and Sensor Information to an XR Server 1004, the XR Server 1004 generates a portion of an XR Scene based on raw XR landscape data and the Tracking and Sensor Information received from the XR Device 1002, and then encodes the portion of the XR Scene and delivers the encoded portion of the XR scene to the XR Device 1002. According to the approach 1000, the XR Device 1002 includes an XR engine or is operably coupled to comprising an XR Engine. The XR engine is a logical (e.g., software) engine deployed at the XR Device 1002 or at the apparatus coupled to the XR device. The XR Engine at the XR Device 1002 then decodes the portion of the XR Scene. This portion of the XR scene is then provided with associated XR metadata to the XR Engine for compiling and rendering. In parallel, the XR Device 1002 also independently generates another portion (e.g., the remainder or less than the remainder) the XR Scene and the XR Engine carries out rendering of the another portion of the XR Scene. The XR Engine then compiles the various portions of the XR Scene to form fully rendered viewport-specific XR media content. As such, part of the XR Scene generation and metadata generation is carried out by the XR Server 1004, while another part of the XR Scene generation is carried out by the XR Device 1002. However, the compiling and full rendering of the viewport-specific XR media content is carried out by the XR Device 1002 prior to display to the user. However, as noted above, with the continued miniaturization of XR user devices and continued use of over-the-air (e.g., 5GIoT) rendered viewport transmission, and with the continued increase in the magnitude of viewport renders being desired for affecting increasingly immersive and seamless user experiences, such re-rendering scenarios may not always be suitable, nor will a single XR Server 1004 be continuously reliable and suitable for providing split rendering services to a split rendering client (e.g., XR Device 1002) due to changing network traffic circumstances and technical issues at an XR Server 1004. As such, as with the approaches (e.g., 500, 600, 700, 800, 900) described above, this approach 1000 also relies on extensive and overly computationally expensive re-rendering of the XR media content at the XR Device 1002 for nearly all rendering activities. However, even if the approach 1000 is suitable for XR Servers 1004 to provide split rendering services to XR Devices 1002 during a particular period of time, the approach 1000 does not provide any manner for seamless relocation of split rendering services from the XR Server 1004 to another XR Server (not shown) in the inevitable circumstance in which QoS and/or QoE of the XR Viewport re-rendered at the XR Device 1002 degrades due to degraded 2D and/or 3D media quality or degrading XR Rendering Metadata quality at the XR Server 1004. In some embodiments, the XR Device 1002 can be the same as, or similar to, the UE 102, the apparatus 300, the XR Device 502, the XR Device 602, the XR Device 702, the XR Device 802, and/or the XR Device 902, whether in terms of structure, subcomponents, arrangement, functionality, and/or the like. In some embodiments, the XR Device 1002 can be a part of the UE 102, the apparatus 300, the XR Device 502, the XR Device 602, the XR Device 702, the XR Device 802, and/or the XR Device 902; or, conversely, the UE 102, the apparatus 300, the XR Device 502, the XR Device 602, the XR Device 702, the XR Device 802, and/or the XR Device 902 can be a part of the XR Device 1002. In some embodiments, the XR Server 1004 can be the same as, or similar to, the CNA 200, the apparatus 400, the XR Server 504, the XR Server 604, the XR Server 704, the XR Server 804, and/or the XR Server 904, whether in terms of structure, subcomponents, arrangement, functionality, and/or the like. In some embodiments, the XR Device 1002 can be a part of the CNA 200, the apparatus 400, the XR Server 504, the XR Server 604, the XR Server 704, the XR Server 804, and/or the XR Server 904; or, conversely, the CNA 200, the apparatus 400, the XR Server 504, the XR Server 604, the XR Server 704, the XR Server 804, and/or the XR Server 904 can be a part of the XR Device 1002.

The viewport-independent XR media delivery approach 1000 illustrated in FIG. 13 can use, be in communication with, or be a part of a communication network, such as a 5GS [fifth-generation system], 6GS [sixth-generation system], a core network (e.g., 5GCN), and/or the like. As illustrated, the XR Server 1004 may be configured to communicate the XR media content to the XR Device 1002 using or with 5GS or the like, such as 100. Further, the XR Device 1002 can be configured to receive the XR media content from the XR Server 904 via such a 5GS or the like, such as 100. In some embodiments, the XR Server 1004 can be a element of a network (e.g., network 100) or network function of the 5GS (e.g., 100). In some other embodiments, the XR Server 1004 can be a part of an edge network or data network in communication with the 5GS (e.g., 100) such that the 5GS can facilitate the transmission of XR media content to the XR Device 1002 and so that components of the 5GS (e.g., RTC-AF 402) can monitor metrics and qualities of the XR media content, functionality of the XR Server 1004, playback of the rendered XR media content at the XR Device 1002, and/or other characteristics or indicators during a split rendering session. Based on this monitoring, the XR Server 1004 or an element or function in the 5GS (e.g., RTC-AF 402) can be configured to initiate, facilitate, or carry out a relocation of the split rendering session from the XR Server 904 to another XR Server (not shown). Embodiments of this relocation procedure are described in more detail elsewhere in this disclosure.

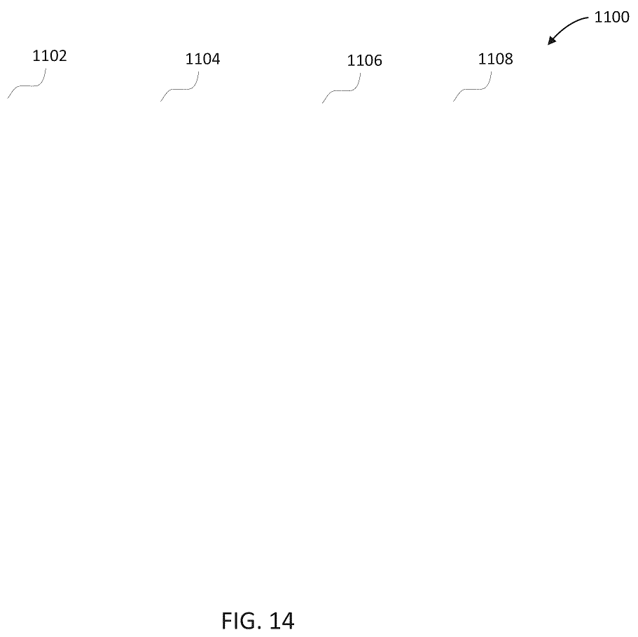

Referring now to FIG. 14, a procedure 1100 is illustrated in which a user equipment 1102 (UE 1102) established an initial split rendering session with a Real-Time Communications Application Server 1104 (RTC-AS 1104) and a RTC-Application Function 1106 (RTC-AF 1106) in order to receive media content from an Application Provider 1108 in a communication network, e.g., a 5G network. The RTC-AF 1106 may be housed at, hosted on, co-provisioned with, mapped to, and/or provided in conjunction with another node or function of a communication network, such as in 100. For example, the RTC-AF 1106 can be a logical function or software-defined function and/or functionality of a session management function (e.g., SMF 110) in the core network (e.g., CN 101), a data server in the data network (e.g., DN 116), an application server or application function (e.g., AS/AF 112), a dedicated server of the core network, and/or the like. The signal flow of the approach 1100 can include the establishment of a split rendering session, or can apply once a split rendering session has already been established with a split-rendering server. For example, at operation 0, a split rendering session is already established between the UE 1102, RTC-AS 1104, RTC-AF 1106, and Application Provider 1108. The subsequent operations (operations 1-5) includes operations of monitoring the split rendering session, (operation 1), provisioning another edge resource (e.g., target split rendering server) once degradation of the XR viewport quality is detected (operation 2), provisioning split rendering service via the target split rendering server in parallel with the split rendering service being provisioned via the existing and/or source split rendering server (operation 3), relocating the split rendering session from the existing and/or source split rendering server to the new and/or target split rendering server (operation 4), and terminating provisioning of the split rendering session via the existing and/or source split rendering server (operation 5), as needed.

In some embodiments, in operation 1, the RTC-AF 1106, which may comprise hardware or be virtualized on a hardware node (e.g., DN 116, SMF 110, etc.) constantly (or regularly) monitors for split-rendering media session degradations. When degradation (e.g., recurrent degradation) of the quality of the rendered viewport, a QoS metric, a QoE metric, or the like is observed, e.g., within a predetermined time period, and/or the severity of degradation of the quality of the rendered viewport is sufficiently severe, the RTC-AF 1106 may indicate to the Application Provider 1108 that the current split rendering session is threatened, and that the split rendering session needs to be relocated.

Then, the approach 1100 can include a step of provisioning and configuring a new split-rendering session. In some embodiments, the same split, or higher configuration of viewport rendering by UE 1102 versus new RTC-AF 1106 can be used. In some embodiments, final say regarding rendering split configuration is left up to the Application Provider 1108.

In some embodiments, in step 2, the Application Provider 1108 requests and sets up the edge server(s) used for the split-rendering, e.g., as described in 3GPP TS 26.506, the entire disclosure of which is hereby incorporated herein by reference in its entirety for all purposes. However, the Application Provider 1108 may use any other suitable method to provision edge servers configurations or leave it to a mobile network operator (currently serving UE 1102 or home network of UE 1102, for example) to set up appropriate edge servers to run the split-rendering process.

In some embodiments, in step 3, the Application Provider 1108 provisions the split-rendering session using a first RTC-AF 1108 and RTC-AS 1104, and sets up the split-rendering session. If the edge servers were provisioned in step 2, the edge servers identifiers may be provided in this split rendering session so the UE 1102 and Application Provider 1108 can consistently usc the same edge server identifiers during provisioning of the new split rendering server by the RTC-AS 1104 and/or RTC-AF 1106 with regard to the split rendering session. In step 4, relocation of the split rendering session to the new split rendering server is achieved. In step 5, once the relocation of the split rendering session to the new split rendering server is complete, the RTC-AF 1106 tells the AP 1108 that the current SRS can be un-provisioned.

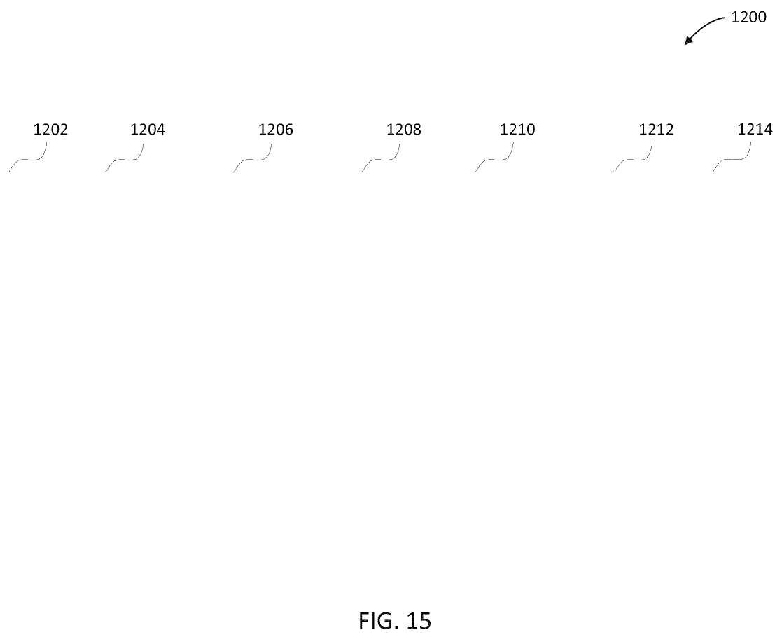

Referring now to FIG. 15, a signaling flow of a process 1200 for setting up a new split rendering service and/or session by a split rendering client 1206 (e.g., UE 102). As illustrated, the process 1200 includes, at step 1, that based on a relocation trigger detected during monitoring of rendered viewport quality from a current split rendering server 1208, an RTC-AF 1212 indicates to an Application Provider 1214 that relocation of the split rendering session to a new split rendering server 1210 needs to be done and/or shall be done. The RTC-AF 1212 may be housed at, hosted on, co-provisioned with, mapped to, and/or provided in conjunction with another node or function of a communication network, such as in 100. For example, the RTC-AF 1212 can be a logical function or software-defined function and/or functionality of a session management function (e.g., SFM 110) in the core network (e.g., CN 101), a data server in the data network (e.g., DN 116), an application server or application function (e.g., AS/AF 112), a dedicated server of the core network, and/or the like. If not already completed, the method 1200 can include the provisioning of the new split rendering server 1210. In some embodiments, an update of the different split rendering session configurations can be carried out by changing these configurations or other settings and/or parameters in ongoing signaling to indicate that the split rendering session is to be relocated from the old split rendering server 1208 to the new split rendering server 1210, that the split rendering client 1206 is in ‘relocation mode’ with regard to the split rendering session, and to populate relocation parameters.

At step 2 of the process 1200, the provisioning of the new split rendering server 1210 is announced to the Application 1202 as part of Service Access Information.

At step 3, the Application 1202 requests client media functions from the split rendering client 1106 to setup a new split-rendering session.

At step 4, the split rendering client 1206 requests that the current split rendering server 1208 transfer relevant configurational information and rendering parameters to the now-provisioned new split rendering server 1210.

In some embodiments, additional steps (e.g., 5-8) can be carried out by the new split rendering server 1210 without sending rendered frames back to the split rendering client 1206. In some embodiments, the negotiation regarding the terms of relocation of the split rendering service and the transition from the current split rendering server 1208 to the new split rendering server 1210 can be addressed during the relocation.

For example, at step 5, the new split rendering server 1210 starts the split rendering process. At step 6, the new split rendering server 1210 establishes a WebRTC session for split rendering of XR viewport for the split rendering client 1206.

At step 7, the new split rendering server 1210 informs the Application 1202 that split rendering is successfully running on the edge resource (i.e., new split rendering server 1210).

At step 8, the split rendering client 1206 sends uplink metadata, such as pose information, action information, positional information, and/or the like, to the new split rendering server 1210. Additionally, in parallel, the split rendering client 1206 sends the uplink metadata, such as pose information, action information, positional information, and/or the like, to the current split rendering server 1208 in addition to sending the same uplink metadata to the new split rendering server 1210.

In some embodiments, the pose information or the like is simply duplicated at the split rendering client 1206 and one of the duplicates is sent to each of the current split rendering server 1208 and the new split rendering server 1210. Alternatively, the pose information can be sent from the split rendering client 1206 to only one of the current split rendering server 1208 or the new split rendering server 1210, and the receiving server (one of 1208 or 1210) forwards the same pose information and the like on to the other server (the other of 1208 or 1210). Additionally or alternatively, the split rendering client 1206 can provide the pose information or the like can be provided to another network-side entity, such as a network entity hosting the RTC-AF 1212 or the Application Provider 1214, which may be a data network (e.g., DN 116) or a session management function (e.g., SMF 110). In some embodiments, the split rendering client 1206 is not able to detect or determine that the degradation of rendered viewport quality is occurring. In some embodiments, the split rendering client 1206 may be able to determine that degradation of the rendered viewport quality is occurring, the split rendering client 1206 may be configured to initiate or request relocation of the split rendering session or split rendering services from the current split rendering server 1208, such as to a new split rendering server 1210. In some embodiments, the RTC-AF 1212 or a media session handler 1204 may receive an indication from another entity that the degradation of rendered viewport quality has occurred (e.g., repeatedly occurred during a particular time period, or has occurred with such severity, as to warrant relocation of the split relocation services to a new split relocation server).

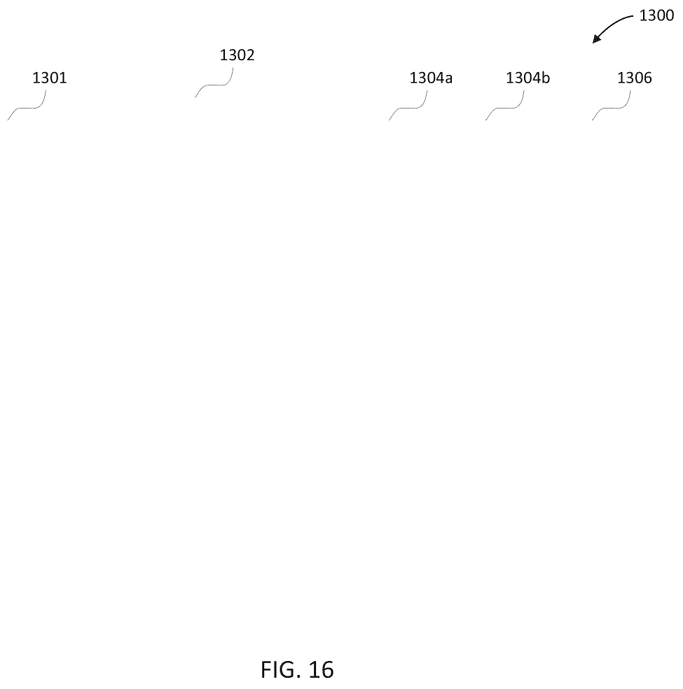

Referring now to FIG. 16, a high-level call flow for an approach 1300 for split rendering service relocation is illustrated, according to an embodiment. In the approach 1300, operations 1-3 include establishing a split rendering session between a split rendering client 1302 and a new split rendering server 1304b in response to a degradation in quality of split rendering at a current split rendering server 1304a. For example, in operation 1 of the approach 1300, an RTC-AF 1306 discovers the new split rendering server 1304b and sets up a connection to it. The RTC-AF 1306 may be housed at, hosted on, co-provisioned with, mapped to, and/or provided in conjunction with another node or function of a communication network, such as in 100. For example, the RTC-AF 1306 can be a logical function or software-defined function and/or functionality of a session management function (e.g., SFM 110) in the core network (e.g., CN 101), a data server in the data network (e.g., DN 116), an application server or application function (e.g., AS/AF 112), a dedicated server of the core network, and/or the like. The new split rendering server 1304b can then provide information about its rendering capabilities and the XR runtime configuration, e.g., an OpenXR configuration may be used for this purpose. In some embodiments, this may be an optional operation, such as when the provisioned new split rendering server 1304b is the same server as the current split rendering server 1304a.

In operation 2 of the approach 1300, in response to being provisioned for split rendering, the new split rendering server 1304b creates a description of expected split rendering output and what input it expects to receive from the split rendering client 1302. This input and output information can be provided from the new split rendering server 1304b to an XR Source Management element of the split rendering client 1302.

In operation 3 of the approach 1300, the split rendering client 1302 may establish transport connections, such as a WebRTC session, and request the buffer streams from a Media Access Function (MAF) of the split rendering client 1302, which in turn establishes a connection to the new split rendering server 1304b to stream pose and retrieve split rendering buffers.

Then, in operations 4-12, the split rendering session relocation process is starting.

In operation 4 of the approach 1300, the RTC-AF 1306 negotiates the split rendering session relocation with the current and new split rendering servers 1304a,b. In some embodiments, the result of this negotiation can be, among other things, a timestamp in the future or a yet-to-be-received frame number, from which the MAF of the split rendering client 1302 will start receiving buffer frame(s) from the new split rendering server 1304b and at which point the current split rendering server 1304a will stop sending buffer frame(s) to the MAF of the split rendering client 1302.

In operation 5 of the approach 1300, the RTC-AF 1306 tells the MAF of the split rendering client 1302 and the current and new split rendering servers 1304a,b to start the split rendering session and/or server relocation process. The RTC-AF 1306 may then indicate, to the MAF of the split rendering client 1302 and the current or new split rendering server 1314a,b, an indication of the point in time or a particular frame at which point the relocation of the split rendering session and/or service will be triggered.

In operation 6 of the approach 1300, the rendering will then temporarily switch from a Rendering Loop to a Rendering Relocation Loop, by an XR Source Manager of the split rendering client 1302 retrieves pose and user input from an XR runtime 1301.

In operation 7 of the approach 1300, the XR Source Manager of the split rendering client 1302 shares the pose predictions and user input actions with the current and new split rendering servers 1304a,b.

In operation 8 of the approach 1300, both the current and new split rendering servers 1304a,b use that pose prediction and user input action information to render XR viewport frames.

In operation 9 of the approach 1300, rendered XR viewport frame can be encoded and streamed downstream to the MAF of the split rendering client 1302. In some embodiments, the source of the frame changes from the current split rendering server 1304a to the new split rendering server 1304b when the transition trigger is reached. As mentioned elsewhere, the transition trigger may be a transition timestamp (point in time at which transition of active viewport rendering from current split rendering server 1304b to new split rendering server 1304b occurs). Additionally or alternatively, the transition trigger may be based on a frame counter (frame number at which point transition of active viewport rendering from current split rendering server 1304b to new split rendering server 1304b occurs).

In operation 10 of the approach 1300, the raw buffer frames are passed from the MAF of the split rendering client 1302 to the XR Runtime 1301 to be displayed to the user.

In operation 11 of the approach 1300, the XR Runtime 1301 achieves the final composition and rendering of the XR viewport based on the raw buffer frames passed from the MAF of the split rendering client 1302 to the XR Runtime 1301.

In operation 12 of the approach 1300, once the transition has been done in the Rendering Relocation Loop, the rendering goes back to the Rendering Loop with the new split rendering server 1304b being the sole or principal rendering server. Thereafter, the relocation procedure ends by closing the established connections.

In operation 13 of the approach 1300, a Scene Manager of the split rendering client 1202 can then terminate the connection with the current split rendering server 1304a.

In some embodiments, when provisioning a split rendering session or new split rendering server, an AF or split rendering client can indicate guidelines for provisioning the session. For example, before or when split rendering session relocation is triggered, the ProvisioningSessionType can be set to “BIDIRECTIONAL.” In some embodiments, the aspId can be configured and can be a unique identifier for an Application Service Provider that offers split rendering. In some embodiments, the externalApplicationld can uniquely identify the application and can be terminated by the sub-string “+3gpp-sr”, such as: “urn:com:example:game+3gpp-sr”.

In some embodiments, edge resource configurations can be set, determined, and communicated between split rendering servers, application functions, and split rendering clients. For example, a split rendering application may define edge resource configurations in a similar manner to 3GPP TS 26.512, version 16.10.0 and version 17.5.0, the entire disclosures of each of which are hereby incorporated herein by reference in their entireties for all purposes. In some embodiments, edge resource configurations can be used for split-rendering session. In some embodiments, eligibilityCriteria can be present and appRequest can be set to true. In some embodiments, easRequirements can indicate “SR” as the easType and can include “3gpp-sr” among the easFeatures. In some embodiments, serviceKpi can be present and indicate split rendering server processing and networking capabilities and requirements.

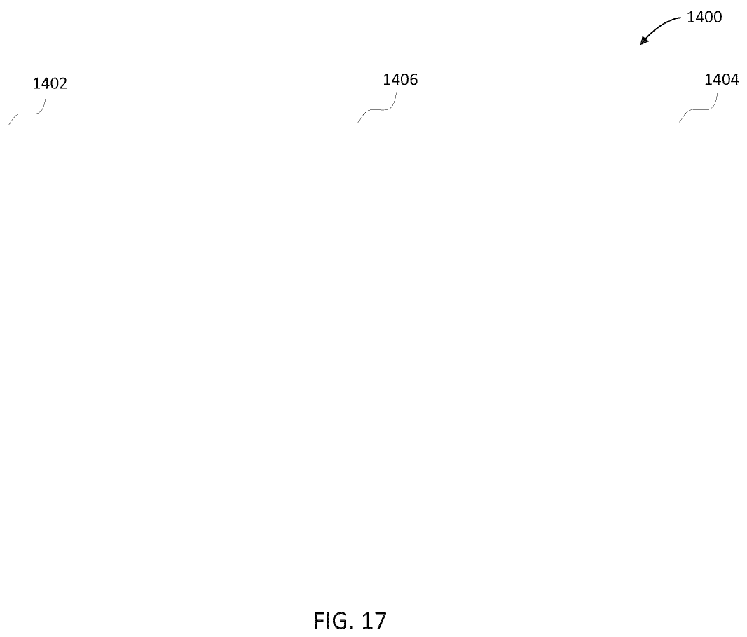

Referring now to FIG. 17, an example split rendering signaling protocol 1400 is illustrated in which both a split rendering client 1402 and a split rendering server 1404 support a Simple WebRTC Application Protocol (SWAP). In some embodiments, the SWAP allows for the definition of application-specific messages, which may be used to establish a split rendering session, trigger relocation of a split rendering session, and handle negotiation of relocation between two different split rendering sessions.

Further details about the SWAP protocol are described in 3GPP TS 26.113, version 0.6.0, the entire disclosure of which is hereby incorporated herein by reference in its entirety for all purposes. In some embodiments, the SWAP protocol may allow for definition of application-specific messages, such as for the establishment of a split rendering session. For Split Rendering, application-specific messages that are supported according to the approach 1400 can include a configuration message that carries the split rendering configuration information from the split rendering client 1402 to the split rendering server 1404. In some embodiments, such messages can be identified by a type “urn:3gpp:sr-msc:sr-configuration”. In some embodiments, a rendering description message may be supported that carries the description of the split rendered media from the split rendering server 1404 to the split rendering client 1402. In some embodiments, the rendering description message can be identified by the type “urn:3gpp:sr-msc:sr-description”. In some embodiments, the rendering description message provides the semantics of the media that is delivered over WebRTC from the split rendering server 1404 to split rendering client 1402.

In some embodiments, a SWAP message exchange for the establishment of a split rendering session, such as is depicted in the call flow diagram of FIG. 17, provides for some possible signaling and call flows with or via a SWAP server 1406.

In some embodiments, the SWAP server 1406 can be or function as an RTC-AF (e.g., 1106, 1212, 1306). In some embodiments, an RTC-AF (e.g., 400) may be housed at, hosted on, co-provisioned with, mapped to, and/or provided in conjunction with the SWAP server 1406. For example, an RTC-AF (e.g., 400) can be a logical function or software-defined function and/or functionality of the SWAP server 1406 in a core network (e.g., CN 101), such as a fifth-generation core network (5GCN), as a data server in a data network (e.g., DN 116), in a radio access network (e.g., (R)AN 104), as an application server or application function (e.g., AS/AF 112), and/or as a dedicated server of the core network, and/or the like.

In some embodiments, possible prerequisites may include that the split rendering client 1302 has discovered the identifier of the split rendering server 1402 that it will use for its split rendering session, that the split rendering client 1402 has retrieved the address of the SWAP server 1406 as part of the configuration, and/or the like.

In some embodiments, the operations of the approach 1400 can include operation 1 in which the split rendering client 1402 sends the configuration message as an application-specific SWAP message to the SWAP server 1406. In some embodiments, the configuration message may provide an identifier indicating the target split rendering server 1404 as a matching criteria.

In operation 2, the SWAP server 1406 may use the provided matching criteria to locate the split rendering server 1404.

In operation 3, the SWAP server 1406 can forward the configuration message to the target split rendering server 1406.

In operation 4, the SWAP server 1406 confirms the successful forwarding of the message to the split rendering client 1402.

In operation 5, the split rendering server 1404 processes the SR configuration message. In some embodiments, the split rendering server 1404 may, for example, verify application and resource availability, launch the application, configure its rendering, and create a rendering description.

In operation 6, the split rendering server 1404 sends the rendering description message as an application-specific SWAP message to the SWAP server 1406.

In operation 7, the SWAP server 1406 forwards the application-specific SWAP message to the split rendering client 1402.

In operation 8, the SWAP server 1406 acknowledges, to the split rendering server 1404, the successful forwarding of the application-specific SWAP message to the split rendering client 1402.

In operation 9, the split rendering client 1402 processes the rendering description and identifies the required data channel and media sessions.

In operation 10, the split rendering client 1402 sends a connect message with the SDP offer to the split rendering server 1404. The SDP offer may reflect the negotiated media and data channel streams.

In operation 11, the SWAP server 1406 acknowledges the forwarding of the connect message with the SDP offer to the split rendering server 1404.

In operation 12, the split rendering server 1404 replies to the SWAP server 1406 with an accept message that includes the SDP answer. The SDP answer reflects the information that was provided in the split rendering description.

In operation 13, the SWAP server 1406 acknowledges, to the split rendering server 1304, the forwarding of the accept message to the split rendering client 1402.

In some embodiments, a variety of such application-specific messages can be supported, such as messages that facilitate relocation negotiation between two split rendering sessions. For example, during a split rendering session transfer and/or relocation, the such application-specific message can include a rendering transfer description message that carries a description of the session transfer to be done from the current split rendering server 1404 to a new split rendering server (not shown). The rendering transfer description message can be identified by the type “urn:3gpp:sr-mse:sr-transfer”. The rendering transfer description message can provide the semantics of the media that is delivered over WebRTC from the split rendering server 1404 to the split rendering client 1402.

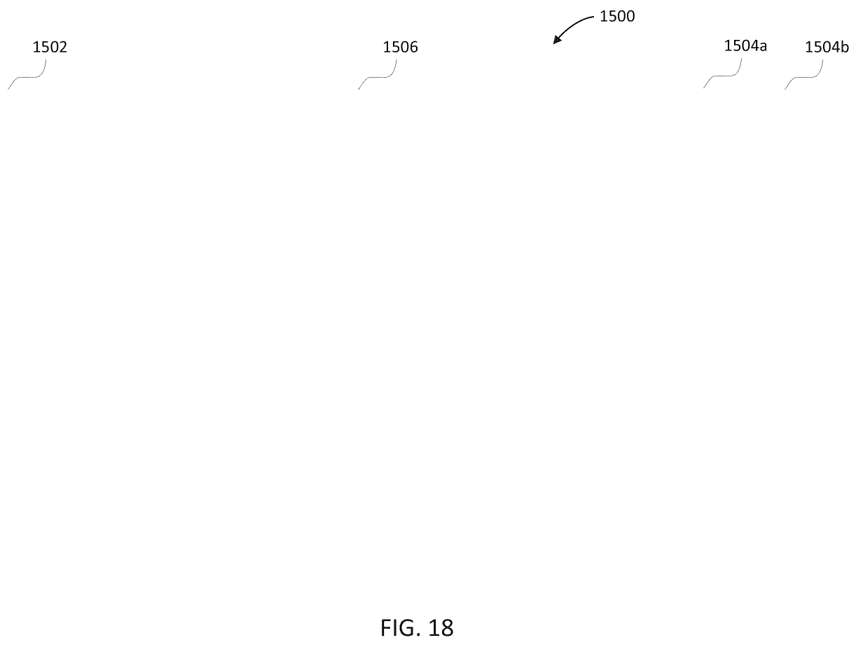

Referring now to FIG. 18, an approach 1500 for SWAP message exchange for the negotiation of a split rendering session relocation can be carried out as illustrated. In the illustrated approach, various possible prerequisites for such negotiation and SWAP message exchange can include that a split rendering client 1502 has discovered an identifier of a new split rendering server 1504b that will be used during relocation of the split rendering session from a current split rendering server 1504a to the new split rendering server 1504b, and/or that the split rendering client 1502 has retrieved the address of a SWAP server 1506 as part of the configuration.

As illustrated in FIG. 18, the approach 1500 includes operation 1 in which the split rendering client 1502 sends the configuration transfer message as an application-specific SWAP message to the SWAP server 1506. It provides the identifier of both the current split rendering server 1504a and the new split rendering server 1504b.

In operation 2 of the approach 1500, the SWAP server 1506 uses the provided matching criteria to locate the current split rendering server 1504a and the new split rendering server 1504b.

In operation 3 of the approach 1500, the SWAP server 1506 forwards the configuration transfer message to the current split rendering server 1504a.

In operation 4 of the approach 1500, the SWAP server 1506 confirms the successful forwarding of the message to the split rendering client 1502.

In operation 5 of the approach 1500, the current split rendering server 1504a processes the split rendering session transfer configuration message. It may prepare the configuration message and runtime information to be sent to the new split rendering server 1504b.

In operation 6 of the approach 1500, the current split rendering server 1504a sends the configuration message to the SWAP server 1506. The current split rendering server 1504a provides the identifier of the new split rendering server 1504b targeted for relocation of the split rendering session.

In operation 7 of the approach 1500, the SWAP server 1506 forwards the configuration message to the new split rendering server 1504b.

In operation 8 of the approach 1500, the SWAP server 1506 confirms the successful forwarding of the message to the new split rendering server 1504b.

In operation 9 of the approach 1500, the new split rendering server 1504b processes the split rendering session transfer configuration message. In some embodiments, the new split rendering server 1504b may verify application and resource availability, launch the application, configure its rendering, and/or create a rendering description.

In operation 10 of the approach 1500, the new split rendering server 1504b sends the rendering description message as an application-specific SWAP message to the SWAP server 1506.

In operation 11 of the approach 1500, the SWAP server 1506 forwards the message to the split rendering client 1502.

In operation 12 of the approach 1500, the SWAP server 1506 acknowledges the successful forwarding of the message to the new split rendering server 1504b.

In operation 13 of the approach 1500, the new split rendering server 1504b processes the rendering description and identifies the required data channel and media sessions.

In operation 14 of the approach 1500, the split rendering client 1502 sends a connect message with the SDP offer to the new split rendering server 1504b. The offer reflects the negotiated media and data channel streams.

In operation 15 of the approach 1500, the SWAP server 1506 acknowledges the forwarding of the message to the new split rendering server 1504b.

In operation 16 of the approach 1500, the new split rendering server 1504b replies with an accept message that includes the SDP answer. The SDP answer reflects the information that was provided in the split rendering description.

In operation 17 of the approach 1500, the SWAP server 1506 acknowledges the forwarding of the message to the split rendering client 1502.

In some embodiments, a particular format, such as message format, or message contents, can be used to indicate the triggering of a split rendering session relocation. In that regard, session transfer configuration information such as that shown below in Table 3 in, e.g., JSON format, can be used to identify and signal relevant split rendering session transfer and configurational information.

TABLE 3

| Name | Type | Cardinality | Description |
|---|---|---|---|
| sourceId | Object | 1 . . . 1 | The identifiers of the current split |
| | | | rendering server (e.g., 1504a) from which |
| | | | the transfer will be done. |
| destId | Object | 1 . . . 1 | The identifiers of the to-be-provisioned |
| | | | new split rendering server (e.g., 1504b), |
| | | | the target of the relocation. |
| transferConfiguration | Object | 1 . . . 1 | The expected transfer configuration, |
| | | | including time window for relocation. |

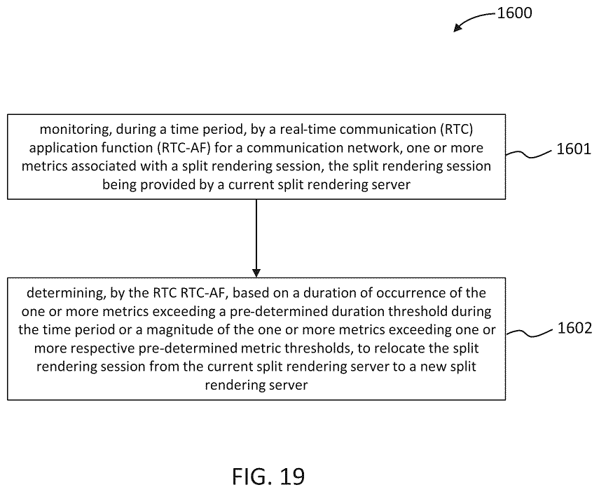

Referring now to FIGS. 19-23, various methods are described and illustrated for monitoring of QoE metrics and/or QoS metrics and seamless transfer of a split rendering session between split rendering servers. In some embodiments, the CNA 200 and/or the apparatus 300 can be configured to carry out some or all portions of any of the methods described herein. For instance, in some embodiments, the CNA 200 and/or the apparatus 300 can include means, such as the processor 202, 304, the memory 204, 306, 308, the communication interface 206, and/or the like.

Referring now to FIG. 19, a method 1600 can be carried out by an apparatus, e.g., the CNA 200 and/or the apparatus 400, which may comprise means, such as a processor (e.g., 202, 404), a memory device (e.g., 204, 406) storing computer program code (e.g., 408) for an RTC-AF (e.g., 400), and/or a communications interface (e.g., 206), wherein when the computer program code (e.g., 408) is executed by the processor (e.g., 202, 404) causes the apparatus to perform at least monitoring, during a time period, by a real-time communication (RTC) application function (RTC-AF) for a communication network, one or more metrics associated with a split rendering session, the split rendering session being provided by a current split rendering server, at 1601. In some embodiments, the method 1600 can further comprise determining, by the RTC RTC-AF, based on a duration of occurrence of the one or more metrics exceeding a pre-determined duration threshold during the time period or a magnitude of the one or more metrics exceeding one or more respective pre-determined metric thresholds, to relocate the split rendering session from the current split rendering server to a new split rendering server, at 1602. In some embodiments, the apparatus configured to carry out the method 1600 may comprise computer program code for an RTC-AF and may also include computer code for a session management function (SMF) or another suitable element or function of the communication network. In some embodiments, the apparatus may be a data server in a data network (DN). In some embodiments, the apparatus may comprise CNA 200 and the computer program code of the CNA 200 may comprise computer program code for the RTC-AF and computer program code for one or more of a policy control function (PCF), an access and mobility management function (AMF), NSSF, AUSF, UDM, NRF, and/or UPF of a core network of the communication network.

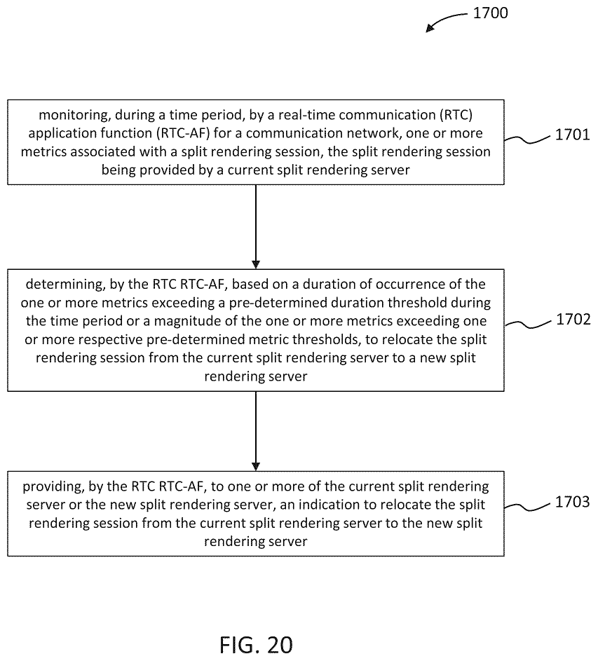

Referring now to FIG. 20, a method 1700 can be carried out by an apparatus, e.g., the CNA 200 and/or the apparatus 400, which may comprise means, such as a processor (e.g., 202, 404), a memory device (e.g., 204, 406) storing computer program code or instructions (e.g., 408) for an RTC-AF (e.g., 400), and/or a communications interface, wherein the computer program code or instructions (e.g., 408) when executed by the processor (e.g., 202, 404) causes the apparatus to perform at least monitoring, during a time period, one or more metrics associated with a split rendering session, the split rendering session being provided by a current split rendering server, at 1701. In some embodiments, the method 1700 can further comprise determining, by the RTC RTC-AF, based on a duration of occurrence of the one or more metrics exceeding a pre-determined duration threshold during the time period or a magnitude of the one or more metrics exceeding one or more respective pre-determined metric thresholds, to relocate the split rendering session from the current split rendering server to a new split rendering server, at 1702. In some embodiments, the method 1700 can further comprise providing, by the RTC RTC-AF, to one or more of the current split rendering server or the new split rendering server, an indication to relocate the split rendering session from the current split rendering server to the new split rendering server, at 1703. In some embodiments, the apparatus configured to carry out the method 1700 may comprise computer program code or instructions for RTC-AF may also include computer code or instructions for a session management function (SMF). In some embodiments, the apparatus may be a data server in a data network (DN). In some embodiments, the apparatus may comprise CNA 200 and the computer program code or instructions of the CNA 200 may comprise computer program code or instructions for the RTC-AF and computer program code or instructions for one or more of a policy control function (PCF), an access and mobility management function (AMF), NSSF, AUSF, UDM, NRF, and/or UPF of a core network of the communication network. In some embodiments, the RTC-AF can be hosted in a session management function (SMF), a data server in a data network (DN), a policy control function (PCF), an access and mobility management function (AMF), NSSF, AUSF, UDM, NRF, UPF, and/or the like.

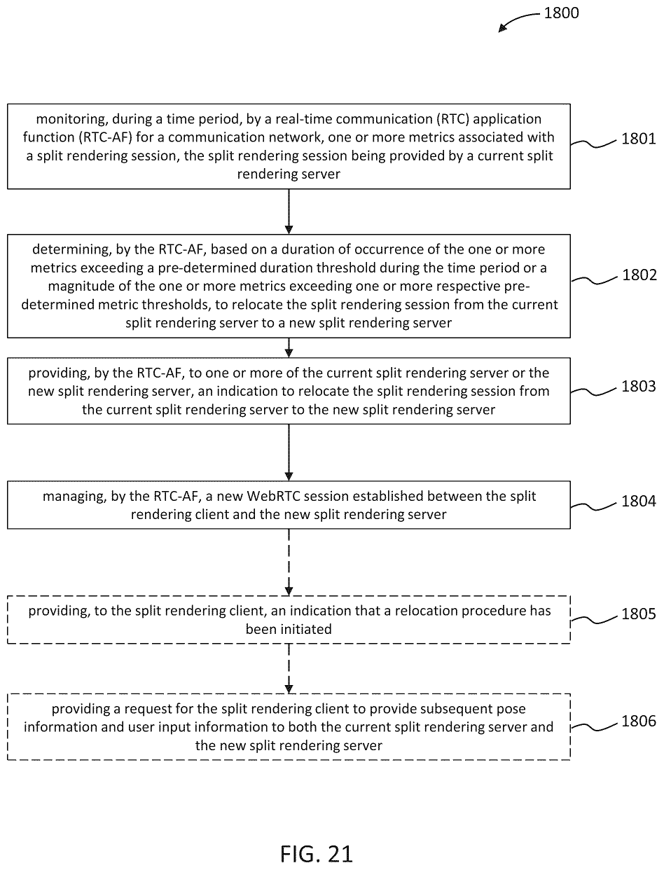

Referring now to FIG. 21, a method 1800 can be carried out by an apparatus, e.g., the CNA 200 and/or the apparatus 400, which may comprise means, such as a processor (e.g., 202, 404), a memory device (e.g., 204, 406) storing computer program code or instructions (e.g., 408), and/or a communications interface, which can cause at least monitoring, during a time period, by an RTC-AF (e.g., RTC-AF 400) for a communication network, one or more metrics associated with a split rendering session, the split rendering session being provided 81urrentt split rendering server, at 1801. In some embodiments, the method 1800 can further comprise determining, by the RTC-AF, based on a duration of occurrence of the one or more metrics exceeding a pre-determined duration threshold during the time period or a magnitude of the one or more metrics exceeding one or more respective pre-determined metric thresholds, to relocate the split rendering session from the current split rendering server to a new split rendering server, at 1802. In some embodiments, the method 1800 can further comprise providing, by the RTC-AF, to one or more of the current split rendering server or the new split rendering server, an indication to relocate the split rendering session from the current split rendering server to the new split rendering server, at 1803. In some embodiments, the method 1800 can further comprise requesting, by the RTC-AF, establishment of a new WebRTC session between the new split rendering server and the RTC-AF, at 1804. In some embodiments, the method 1800 can, optionally, further comprise providing, to the split rendering client, an indication that a relocation procedure has been initiated, at 1805. In some embodiments, the method 1800 can, optionally, further comprise providing a request for the split rendering client to provide subsequent pose information and user input information to both the current split rendering server and the new split rendering server, at 1806. In some embodiments, the apparatus configured to carry out the method 1800 may comprise computer program code or instructions for an RTC-AF and may also include computer code for a session management function (SMF) or another suitable element or network function of the communication network. In some embodiments, the apparatus may be a data server in a data network (DN). In some embodiments, the apparatus may comprise CNA 200 and the computer program code or instructions of the CNA 200 may comprise computer program code or instructions for the RTC-AF and computer program code or instructions for one or more of a policy control function (PCF), an access and mobility management function (AMF), NSSF, AUSF, UDM, NRF, and/or UPF of a core network of the communication network. In some embodiments, the RTC-AF can be hosted in a session management function (SMF), a data server in a data network (DN), a policy control function (PCF), an access and mobility management function (AMF), NSSF, AUSF, UDM, NRF, UPF, and/or the like.

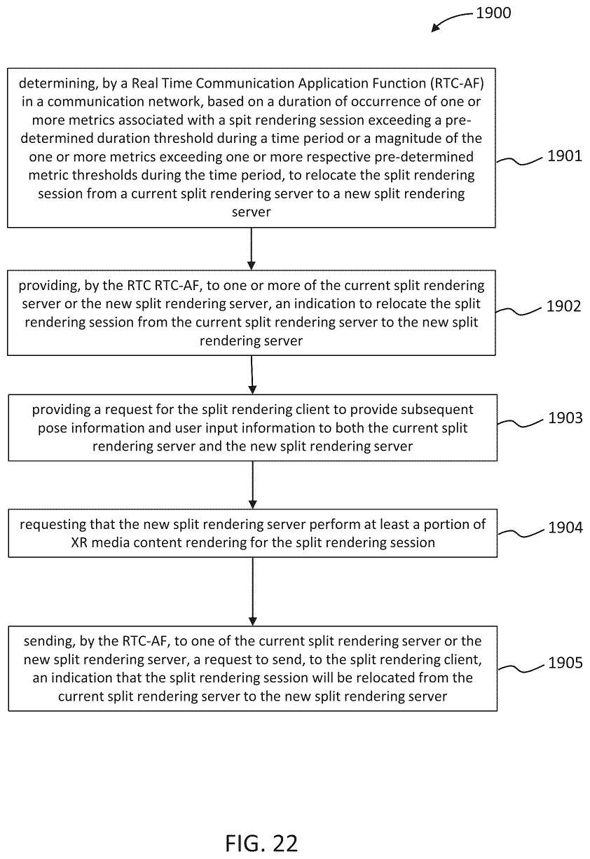

Referring now to FIG. 22, a method 1900 can be carried out by an apparatus, e.g., the CNA 200 and/or the apparatus 400, which may comprise means, such as a processor (e.g., 202, 404), a memory device (e.g., 204, 406) storing computer program code (e.g., 408) for an RTC-AF (e.g., 400), and/or a communications interface, which when executed by the processor can cause the apparatus to perform at least determining, by a Real Time Communication Application Function (RTC-AF) in a communication network, based on a duration of occurrence of one or more metrics associated with a spit rendering session exceeding a pre-determined duration threshold during a time period or a magnitude of the one or more metrics exceeding one or more respective pre-determined metric thresholds during the time period, to relocate the split rendering session from a current split rendering server to a new split rendering server, at 1901. In some embodiments, the method 1900 can further comprise providing, by the RTC RTC-AF, to one or more of the current split rendering server or the new split rendering server, an indication to relocate the split rendering session from the current split rendering server to the new split rendering server, at 1902. In some embodiments, the method 1900 can further comprise providing a request for the split rendering client to provide subsequent pose information and user input information to both the current split rendering server and the new split rendering server, at 1903. In some embodiments, the method 1900 can further comprise requesting that the new split rendering server perform at least a portion of XR media content rendering for the split rendering session, at 1904. In some embodiments, the method 1900 can further comprise sending, by the RTC-AF, to one of the current split rendering server or the new split rendering server, a request to send, to the split rendering client, an indication that the split rendering session will be relocated from the current split rendering server to the new split rendering server, at 1905. In some embodiments, the apparatus configured to carry out the method 1900 may comprise computer program code or instructions for a RTC-AF may also include computer code or instructions for a session management function (SMF). In some embodiments, the apparatus may be a data server in a data network (DN). In some embodiments, the apparatus may comprise CNA 200 and the computer program code or instructions of the CNA 200 may comprise computer program code or instructions for the RTC-AF and computer program code or instructions for one or more of a policy control function (PCF), an access and mobility management function (AMF), NSSF, AUSF, UDM, NRF, and/or UPF of a core network of the communication network. In some embodiments, the RTC-AF can be hosted in a session management function (SMF), a data server in a data network (DN), a policy control function (PCF), an access and mobility management function (AMF), NSSF, AUSF, UDM, NRF, UPF, and/or the like.

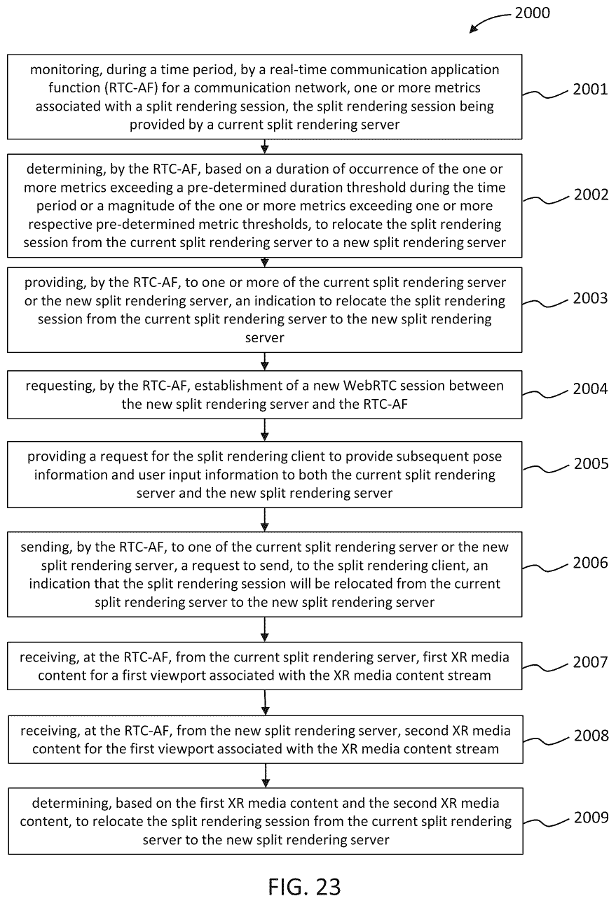

Referring now to FIG. 23, a method 2000 can be carried out by an apparatus, e.g., the CNA 200 and/or the apparatus 400, which may comprise means, such as a processor (e.g., 202, 404), a memory device (e.g., 204, 406) storing computer program code (e.g., 408) for an RTC-AF (e.g., 400), and/or a communications interface, which can cause at least monitoring, during a time period, by a real-time communication application function (RTC-AF) for a communication network, one or more metrics associated with a split rendering session, the split rendering session being provided by a current split rendering server, at 2001. In some embodiments, the method 2000 can further comprise determining, by the RTC-AF, based on a duration of occurrence of the one or more metrics exceeding a pre-determined duration threshold during the time period or a magnitude of the one or more metrics exceeding one or more respective pre-determined metric thresholds, to relocate the split rendering session from the current split rendering server to a new split rendering server, at 2002. In some embodiments, the method 2000 can further comprise providing, by the RTC-AF, to one or more of the current split rendering server or the new split rendering server, an indication to relocate the split rendering session from the current split rendering server to the new split rendering server, at 2003. In some embodiments, the method 2000 can further comprise requesting, by the RTC-AF, establishment of a new WebRTC session between the new split rendering server and the RTC-AF, at 2004. In some embodiments, the method 2000 can further comprise providing a request for the split rendering client to provide subsequent pose information and user input information to both the current split rendering server and the new split rendering server, at 2005. In some embodiments, the method 2000 can further comprise sending, by the RTC-AF, to one of the current split rendering server or the new split rendering server, a request to send, to the split rendering client, an indication that the split rendering session will be relocated from the current split rendering server to the new split rendering server, at 2006. In some embodiments, the method 2000 can further comprise receiving, at the RTC-AF, from the current split rendering server, first XR media content for a first viewport associated with the XR media content stream, at 2007. In some embodiments, the method 2000 can further comprise receiving, at the RTC-AF, from the new split rendering server, second XR media content for the first viewport associated with the XR media content stream, at 2008. In some embodiments, the method 2000 can further comprise determining, based on the first XR media content and the second XR media content, to relocate the split rendering session from the current split rendering server to the new split rendering server, at 2009. In some embodiments, the apparatus configured to carry out the method 2000 may comprise computer program code for an RTC-AF and computer program code for a session management function (SMF) or other suitable network node or element of the network (generally referred to as a network element) at which the RTC-AF can be collocated. In some embodiments, the RTC-AF can be a standalone entity or be collocated with other functional entities in the communication network, such as the application server (AS), NEF, PCF, UPF, and/or the like. The RTC-AF can be collocated with the AS to directly integrate application-level services with the network and to facilitate real-time communication services. In some embodiments, the RTC-AF can be collocated with the NEF to enable secure exposure of the AF services and capabilities to third-party applications and services. In some embodiments, the RTC-AF can be collocated with the PCF to streamline the interactions between the application functions and policy control mechanisms. In some embodiments, the RTC-AF can be collocated with a UPF, which may help to optimize the user plane traffic routing for real-time communication services.

### Network Exposure Function (NEF

In some embodiments, the apparatus may be a data server in a data network (DN). In some embodiments, the apparatus may comprise CNA 200 and the computer program code may include computer program code for the RTC-AF and computer program code for one or more of a policy control function (PCF), an access and mobility management function (AMF), NSSF, AUSF, UDM, NRF, and/or UPF of a core network of the communication network. In some embodiments, the RTC-AF can be hosted in a session management function (SMF), a data server in a data network (DN), a policy control function (PCF), an access and mobility management function (AMF), NSSF, AUSF, UDM, NRF, UPF, and/or the like.

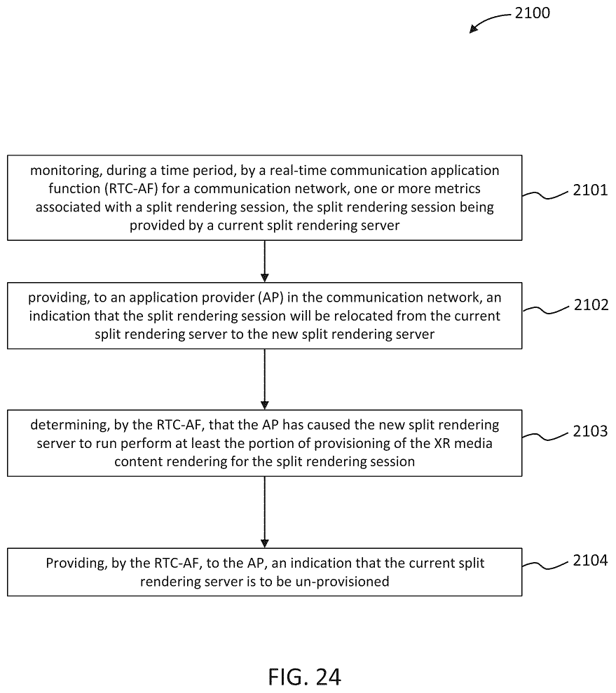

Referring now to FIG. 24, a method 2100 can be carried out by an apparatus, e.g., the CNA 200 and/or the apparatus 400, which may comprise means, such as a processor (e.g., 202, 404), a memory device (e.g., 204, 406) storing computer program code or instructions (e.g., 408) for an RTC-AF (e.g., 400), and/or a communications interface, wherein the computer program code or instructions (e.g., 408) when executed by the processor (e.g., 202, 404) cause the apparatus to at least monitoring, during a time period, one or more metrics associated with a split rendering session, the split rendering session being provided by a current split rendering server, at 2101. In some embodiments, the method 2100 can further comprise providing, to an application provider (AP) in the communication network, an indication that the split rendering session will be relocated from the current split rendering server to the new split rendering server, at 2102. In some embodiments, the method 2100 can further comprise determining, by the RTC-AF, that the AP has caused the new split rendering server to run perform at least the portion of provisioning of the XR media content rendering for the split rendering session, at 2103. In some embodiments, the method 2100 can further comprise Providing, by the RTC-AF, to the AP, an indication that the current split rendering server is to be un-provisioned, at 2104. In some embodiments, the method 2100 can be carried out by an apparatus such as the RTC-AF 402, that comprises computer program code for an RTC-AF and computer program code for a session management function (SMF). In some embodiments, the apparatus may be a data server in a data network (DN). In some embodiments, the apparatus may be or comprise the CNA 200 and the computer program code or instructions may include computer program code or instructions for the RTC-AF (e.g., 402) and computer program code or instructions for one or more of a policy control function (PCF), an access and mobility management function (AMF), NSSF, AUSF, UDM, NRF, or UPF in a core network of the communication network, among other network elements or functions.

As described above, FIGS. 19-24 are flowcharts of methods that can be carried out by an apparatus according to related computer program products comprising computer program code. It will be understood that each block of the flowcharts, and combinations of blocks in the flowcharts, may be implemented by various means, such as hardware, firmware, processor (e.g., 202, 304, 404), circuitry, and/or other devices associated with execution of software including one or more computer program instructions. For example, one or more of the procedures described above may be embodied by computer program instructions. In this regard, the computer program instructions which embody the procedures described above may be stored by a memory device (e.g., 204, 306, 308, 406), of an apparatus, e.g., 200, 300, 400, employing an embodiment of the present disclosure and executed by processing circuitry, e.g., 202, 304, 404 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as in conjunction with the flowcharts of at least FIGS. 19-24. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation. Any application, publication, technical document, or the like that is cited in this disclosure is hereby incorporated herein by reference in its entirety for all purposes.

In general, the routines executed to implement the embodiments, whether implemented as part of an operating system or a specific application, component, program, object, module or sequence of instructions, or even a subset thereof, may be referred to herein as “computer program code” or simply “program code”. Program code typically comprises computer-readable instructions that are resident at various times in various memory devices (e.g., 204, 306, 308, 404) and storage devices in a computer and that, when read and executed by one or more processors (e.g., 202, 302, 402) in the computer, cause the computer to perform the operations necessary to execute operations and/or elements embodying the various aspects of the embodiments of the present disclosure. Computer readable program instructions for carrying out operations of the embodiments of the invention may be, for example, assembly language or either source code or object code written in any combination of one or more programming languages.

In certain alternative embodiments, the functions and/or acts specified in the flowcharts, sequence diagrams, and/or block diagrams may be re-ordered, processed serially, and/or processed concurrently without departing from the scope of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the disclosure. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While a description of various embodiments has illustrated all of the inventions and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the applicant's general inventive concept.

1. An apparatus for a communication network, the apparatus comprising:
at least one processor; and
at least one memory storing instructions of a real-time communication application function (RTC-AF), wherein the instructions, when executed by the at least one processor, cause the apparatus to perform at least:
monitoring, during a time period, one or more metrics associated with a split rendering session, the split rendering session being provided by a current split rendering server,
wherein the split rendering session is associated with an extended reality (XR) media content stream being provided to a split rendering client by the current split rendering server,
wherein the one or more metrics comprise one or more of: a quality of service (QoS) metric, a quality of experience (QoE) metric, a key performance indicator (KPI) of the current split rendering server, or a metric associated with the XR media content stream,
determining, based on a duration of occurrence of the one or more metrics exceeding a pre-determined duration threshold during the time period or a magnitude of the one or more metrics exceeding one or more respective pre-determined metric thresholds, to relocate the split rendering session from the current split rendering server to a new split rendering server; and
providing, to one or more of the current split rendering server or the new split rendering server, an indication to relocate the split rendering session from the current split rendering server to the new split rendering server.

2. The apparatus of claim 1, wherein the QoS metric is selected from among: a packet loss rate, a bit rate, a bandwidth, a latency, a variance in latency, a throughput, a transmission delay, an availability, or a jitter.

3. The apparatus of claim 1, wherein the instructions stored on the at least one memory, when executed by the at least one processor, further cause the apparatus to perform:
managing a new WebRTC session established between the split rendering client and the new split rendering server.

4. The apparatus of claim 1, wherein the instructions stored on the at least one memory, when executed by the at least one processor, further cause the apparatus to perform:
providing, to the split rendering client, an indication that a relocation procedure has been initiated.

5. The apparatus of claim 4, wherein the instructions stored on the at least one memory, when executed by the at least one processor, further cause the apparatus to perform:
providing a request for the split rendering client to provide subsequent pose information and user input information to both the current split rendering server and the new split rendering server.

6. The apparatus of claim 1, wherein the instructions stored on the at least one memory, when executed by the at least one processor, further cause the apparatus to perform:
sending, to one of the current split rendering server or the new split rendering server, a request to send, to the split rendering client, an indication that the split rendering session will be relocated from the current split rendering server to the new split rendering server.

7. The apparatus of claim 1, wherein the instructions stored on the at least one memory, when executed by the at least one processor, further cause the apparatus to perform:
receiving, from the current split rendering server, first XR media content for a first viewport associated with the XR media content stream;
receiving, from the new split rendering server, second XR media content for the first viewport associated with the XR media content stream; and
determining, based on the first XR media content and the second XR media content, to relocate the split rendering session from the current split rendering server to the new split rendering server.

8. The apparatus of claim 1, wherein the instructions stored on the at least one memory, when executed by the at least one processor, further cause the apparatus to perform:
indicating, to an application provider (AP) in the communication network, that the split rendering session will be relocated from the current split rendering server to the new split rendering server.

9. The apparatus of claim 8, wherein the instructions stored on the at least one memory, when executed by the at least one processor, further cause the apparatus to perform:
requesting that the new split rendering server perform at least a portion of XR media content rendering for the split rendering session.

10. The apparatus of claim 8, wherein the instructions stored on the at least one memory, when executed by the at least one processor, further cause the apparatus to perform:
determining that the AP has caused the current split rendering server to perform at least the portion of the XR media content rendering for the split rendering session; and
providing, to the AP, an indication that the current split rendering server is to be un-provisioned.

11. The apparatus of claim 1, wherein the instructions stored on the at least one memory, when executed by the at least one processor, further cause the apparatus to perform:
determining one or more characteristics of the current and new split rendering servers;
determining, based at least on the one or more characteristics of the current and new split rendering servers, a time for completion of relocation of the split rendering session from the current split rendering server to the new split rendering server; and
sending, to the current split rendering server and the new split rendering server, an indication that the new split rendering server is to relocate the split rendering session from the current split rendering server to the new split rendering server by the time for completion of relocation of the split rendering session.

12. The apparatus of claim 11, wherein the sending of the indication comprises sending an indication of the time for completion of relocation of the split rendering session relative to an XR runtime or relative to a relocation frame identifier indicating a particular frame from a sequence of frames in the XR media content stream by which time the relocation of the split rendering session is to be completed.

13. A method comprising:
monitoring, during a time period, by a real-time communication application function (RTC-AF) for a communication network, one or more metrics associated with a split rendering session, the split rendering session being provided by a current split rendering server,
wherein the split rendering session is associated with an extended reality (XR) media content stream being provided to a split rendering client by the current split rendering server via the communication network,
wherein the one or more metrics comprise one or more of: a quality of service (QoS) metric, a quality of experience (QoE) metric, a key performance indicator (KPI) for the current split rendering server, or a metric associated with the XR media content stream,
determining, by the RTC-AF, based on a duration of occurrence of the one or more metrics exceeding a pre-determined duration threshold during the time period or a magnitude of the one or more metrics exceeding one or more respective pre-determined metric thresholds, to relocate the split rendering session from the current split rendering server to a new split rendering server; and
providing, by the RTC-AF, to one or more of the current split rendering server or the new split rendering server, an indication to relocate the split rendering session from the current split rendering server to the new split rendering server.

14. The method of claim 13, wherein the QoS metric is selected from among: a packet loss rate, a bit rate, a bandwidth, a latency, a variance in latency, a throughput, a transmission delay, an availability, or a jitter.

15. The method of claim 13, further comprising:
managing, by the RTC-AF, a new WebRTC session established between the split rendering client and the new split rendering server.

16. The method of claim 13, further comprising:
providing, to the split rendering client, an indication that a relocation procedure has been initiated.

17. The method of claim 16, further comprising:
providing a request for the split rendering client to provide subsequent pose information and user input information to both the current split rendering server and the new split rendering server.

18. The method of claim 13, further comprising:
sending, by the RTC-AF, to one of the current split rendering server or the new split rendering server, a request to send, to the split rendering client, an indication that the split rendering session will be relocated from the current split rendering server to the new split rendering server.

19. The method of claim 13, further comprising:
receiving, at the RTC-AF, from the current split rendering server, first XR media content for a first viewport associated with the XR media content stream;
receiving, at the RTC-AF, from the new split rendering server, second XR media content for the first viewport associated with the XR media content stream; and
determining, by the RTC-AF, based on the first XR media content and the second XR media content, to relocate the split rendering session from the current split rendering server to the new split rendering server.

20. A non-transitory computer-readable medium storing instructions of a real-time communication application function that, when executed by at least one processor of an apparatus, cause an apparatus to perform:
monitoring, during a time period, one or more metrics associated with a split rendering session, the split rendering session being provided by a current split rendering server,
wherein the split rendering session is associated with an extended reality (XR) media content stream being provided to a split rendering client by the current split rendering server via the communication network,
wherein the one or more metrics comprise one or more of: a quality of service (QOS) metric, a quality of experience (QoE) metric, a key performance indicator (KPI) for the current split rendering server, or a metric associated with the XR media content stream,
determining, based on a duration of occurrence of the one or more metrics exceeding a pre-determined duration threshold during the time period or a magnitude of the one or more metrics exceeding one or more respective pre-determined metric thresholds, to relocate the split rendering session from the current split rendering server to a new split rendering server; and
providing to one or more of the current split rendering server or the new split rendering server, an indication to relocate the split rendering session from the current split rendering server to the new split rendering server.
